(19) United States
(12) Patent Application Publication
(10) Pub. No.: US 2008/0150819 A1
(43) Pub. Date: Jun. 26, 2008

(54) RADAR APPARATUS

(75) Inventors: Hiroyuki Uno, Ishikawa (JP); Yutaka Saitoh, Ishikawa (JP); Tomoya Nakanishi, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/939,196

(22) Filed: Nov. 13, 2007

(30) Foreign Application Priority Data
Nov. 15, 2006 (JP) 2006-308791

(51) Int. Cl. H01Q 3/24; H01Q 13/10

(52) U.S. Cl. 343/770; 343/876

(57) ABSTRACT

A radar apparatus includes:
antenna elements, a transmitter, a receiver, a first antenna switch which selectively connects first power feeding points of each of the plurality of the antenna elements and the transmitter, a second antenna switch which selectively connects second power feeding points of each of the plurality of antenna elements and the receiver, and a control portion which controls a connection of the first and second antenna switch. Two or more of the antenna elements have different directivity.

### BACKGROUND OF THE INVENTION

1. Field of the Invention

The present invention relates to a radar apparatus that can switch detection directions by selectively switching excitation using a plurality of antenna elements.

2. Related Art of the Invention

For an on-vehicle radar system that monitors the area surrounding a vehicle, it is desirable to provide a plurality of radar apparatuses at the front and rear of the vehicle in order to detect obstacles in all directions around the vehicle. There is thus a problem that the system configuration becomes complicated and costs increase. To overcome this problem, studies are underway with the aim of controlling the directivities of antennas to broaden the range that can be detected by a single radar apparatus, and thus reduce the number of radar apparatuses that are mounted on a vehicle.

An on-vehicle radar system that uses a phased array antenna has already been proposed as one such kind of radar system (for example, see Japanese Patent Laid-Open No. 2-287180). The phased array antenna used in this on-vehicle radar system uses a plurality of antenna elements and phase shifters and switches the directivity by controlling the phase shift quantity of each antenna element. This system can thus broaden the detection range and also detect the direction of obstacles with good accuracy. However, the on-vehicle radar system disclosed in Japanese Patent Laid-Open No. 2-287180 requires a plurality of phase shifters in order to switch the directions of the beams of the antennas, and consequently there is the problem that the structure and control are complicated.

Therefore, an on-vehicle radar apparatus in which a plurality of antenna elements (for example, patch antennas) are disposed such that the respective orientation directions are different has been proposed as a radar system that can switch beam directions of an antenna without using a phase shifter (for example, see Japanese Patent Laid-Open No. 8-334557). Since this on-vehicle radar system can vary the detection directions or beam widths of an antenna by controlling the number of antenna elements that are used, the system can broaden the detection range and also detect obstacles with good accuracy irrespective of the detection distance.

However, although the on-vehicle radar apparatus disclosed in the aforementioned Japanese Patent Laid-Open No. 8-334557 makes a connection between a transmitter and receiver and a plurality of antenna elements that use a patch antenna or the like by turning on and off a plurality of switches that correspond to each antenna element, there is a problem that a circulator is used for the connection between each of the antenna elements and the transmitter and receiver and the loss amount of the circulator increases, which leads to a deterioration in reception sensitivity.

### SUMMARY OF THE INVENTION

The present invention has been made in consideration of the above problem, and an object of this invention is to provide a radar apparatus that can prevent a deterioration in reception sensitivity while broadening the detection range using a plurality of antenna elements.

The first aspect of the present invention is a radar apparatus, comprising:

a plurality of antenna elements each having a first power feeding point and a second power feeding point;

a transmitter;

a receiver;

first antenna switch which selectively connects the first power feeding point of each of the plurality of antenna elements and the transmitter;

second antenna switch which selectively connects the second power feeding point of each of the plurality of antenna elements and the receiver; and

a control portion which controls a connection of the first antenna switch and the second antenna switch;

wherein, at least one of the plurality of antenna elements has a directivity different than another of the plurality of antenna elements.

The second aspect of the present invention is the radar apparatus according to the first aspect of the present invention, wherein the control portion controls the first antenna switch and the second antenna switch so that when the first power feeding point of either one of the antenna elements is connected to the transmitter, the second power feeding point of either one of the antenna elements is connected to the receiver at the same time.

The third aspect of the present invention is the radar apparatus according to the second aspect of the present invention, wherein the control portion controls the first antenna switch and the second antenna switch such that:

the first power feeding points of the plurality of antenna elements and the transmitter are sequentially connected;

the second power feeding points of the plurality of antenna elements and the receiver are sequentially connected in a manner that follows the sequential connections of the first power feeding points and the transmitter; and

the antenna element for which the second power feeding point and the receiver are connected is the antenna element for which a connection between the first power feeding point and the transmitter is just after finishing.

The fourth aspect of the present invention is the radar apparatus according to the first aspect of the present invention, wherein the control portion controls the first antenna switch and the second antenna switch so that the second power feeding points of all the antenna element are sequentially connected to the receiver after the first power feeding points of all the antenna elements are sequentially connected to the transmitter.

The fifth aspect of the present invention is the radar apparatus according to the first aspect of the present invention, wherein each of the antenna elements have the same directivity irrespective of whether the antenna elements are fed with power from the first power feeding point or the second power feeding point.

The sixth aspect of the present invention is the radar apparatus according to the first aspect of the present invention, wherein the plurality of antenna elements are each planar antennas that are disposed on the same surface, and are provided with a reflector that is disposed at a predetermined distance from and in parallel with the antenna element surface.

The seventh aspect of the present invention is the radar apparatus according to the first aspect of the present invention, wherein

the transmitter and the receiver transmits and receive pulse signals; and

the control portion controls the first antenna switch or the second antenna switch at a timing of transmitting the pulse signal of the transmitter.

The eighth aspect of the present invention is the radar apparatus according to the first aspect of the present invention, wherein

the plurality of antenna elements includes a first antenna element and a second antenna element.

The ninth aspect of the present invention is the radar apparatus according to the sixth aspect of the present invention, wherein

the antenna elements comprise:

diamond-shaped antenna portions in which a first to a fourth linear conducting element that have a length of from a ¼ wavelength to a ⅜ wavelength of a usable frequency of the transmitter and the receiver are disposed in a diamond shape, and in which the first linear conducting element and the second linear conducting element that are adjacent are connected and the third linear conducting element and the fourth linear conducting element that are adjacent are connected;

linear coupling elements having a predetermined length which, for a pair of the diamond-shaped antenna portions that are facing each other, connect the second linear conducting element of one of the diamond-shaped antenna portions with the first linear conducting element of the other of the diamond-shaped antenna portions and connect the fourth linear conducting element of the one of the diamond-shaped antenna portions with the third linear conducting element of the other of the diamond-shaped antenna portions to thereby link a plurality of the diamond-shaped antenna portions; and

fold shape linear detour elements that have a predetermined length overall that respectively connect the first linear conducting element and the third linear conducting element of the diamond-shaped antenna portion at one end of the plurality of the diamond-shaped antenna portions that are linked, and the second linear conducting element and the fourth linear conducting element of the diamond-shaped antenna portion at another end of the plurality of the diamond-shaped antenna portions that are linked;

wherein the first power feeding point and the second power feeding point are respectively provided in a connection portion between the first linear conducting element and the second linear conducting element of any two diamond-shaped antenna portions of the plurality of diamond-shaped antenna portions.

The tenth aspect of the present invention is the radar apparatus according to the ninth aspect of the present invention, wherein the predetermined length of the linear detour element and a predetermined space from the antenna element to the reflector differs for each of a plurality of the antenna elements in accordance with a directivity of the antenna element.

The eleventh aspect of the present invention is the radar apparatus according to the sixth aspect of the present invention, wherein each antenna element comprises:

a dielectric substrate having a predetermined dielectric constant;

a conductor layer that is formed on the dielectric substrate;

array antenna slots formed on the conductor layer and having:

diamond-shaped antenna slots in which a first to a fourth linear slot having a length of from ¼ wavelength to ⅜ wavelength of a usable frequency of the transmitter and the receiver are disposed in a diamond shape, and in which the first linear slot and the second linear slot that are adjacent are connected and the third linear slot and the fourth linear slot that are adjacent are connected,

linear coupling slots having a predetermined length which, for a pair of the diamond-shaped antenna slots that are facing each other, connect the second linear slot of one of the diamond-shaped antenna slots with the first linear slot of the other of the diamond-shaped antenna slots and connect the fourth linear slot of the one of the diamond-shaped antenna slots with the third linear slot of the other of the diamond-shaped antenna slots to thereby link a plurality of the diamond-shaped antenna slots, and

fold shape linear detour slots that have a predetermined length overall that respectively connect the first linear slot and the third linear slot of the diamond-shaped antenna slot at one end of the plurality of the diamond-shaped antenna slots that are linked, and the second linear slot and the fourth linear slot of the diamond-shaped antenna slot at another end of the plurality of the diamond-shaped antenna slots that are linked; and

connection conductors that are disposed so as to be separated from each of the first to the fourth linear slots of at least one diamond-shaped antenna slot of the array antenna slots;

wherein, the first power feeding point and the second power feeding point are respectively provided in a connection portion of the first linear slot and the second linear slot of any two diamond-shaped antenna slots of the plurality of diamond-shaped antenna slots.

The twelfth aspect of the present invention is the radar apparatus according to the eleventh aspect of the present invention, wherein the predetermined length of the linear detour slot and a predetermined space from the antenna element to the reflector differs for each of a plurality of the antenna elements in accordance with a directivity of the antenna element.

The thirteenth aspect of the present invention is the radar apparatus according to the twelfth aspect of the present invention, further comprising microstrip lines that are respectively disposed in the first power feeding point and the second power feeding point provided on a surface on an opposite side to a surface on which the conductor layer of the dielectric substrate is formed.

The fourteenth aspect of the present invention is the radar apparatus according to the eleventh aspect of the present invention, further comprising:

a conductor plate that is disposed so as to connect the reflector and the dielectric substrate.

The fifteen aspect of the present invention is the radar apparatus according to the eleventh aspect of the present invention, further comprising at least one waveguide element having a length that is less than or equal to half a wavelength of the usable frequency and which is formed in a condition in which the waveguide elements are separated by a predetermined distance on a same surface of a plurality of the antenna elements.

The sixteenth aspect of the present invention is the radar apparatus according to the eleventh aspect of the present invention, further comprising at least one reflection element having a length that is less than or equal to half a wavelength of the usable frequency and which is formed in a condition in which the reflection elements are separated by a predetermined distance on a same surface of a plurality of the antenna elements.

According to this configuration, a radar apparatus with a planar structure and excellent productivity that can switch a detection range by switching two antenna elements can be realized. Further, by providing two feeding points in each antenna element and sharing a transmitting and receiving circuit, common components are unnecessary and the reception sensitivity can be improved.

According to this configuration, a radar apparatus can be realized with good reception sensitivity over a wide range and for which there is little loss in a detection range that can be detected by a single antenna element even when a power feeding point that is connected to the transmitting and receiving circuit is different.

According to this configuration, a radar apparatus can be realized that can detect obstacles that exist at a short distance.

According to this configuration, a radar apparatus can be realized that has good reception sensitivity and which can switch a detection range with a planar structure.

According to this configuration, a radar apparatus can be realized that has good reception sensitivity and which can switch a detection range with a planar structure.

According to this configuration, impedance matching can be performed by regulating the length of a microstrip line to facilitate the supply of power, and the productivity of the radar apparatus can also be enhanced.

According to this configuration, a radar apparatus can be realized that has directivity with an excellent F/B ratio (ratio between main lobe and back lobe).

According to this configuration, a radar apparatus can be realized that has directivity with an excellent F/B ratio and a high gain.

According to this configuration, a radar apparatus can be realized that has directivity with an excellent F/B ratio and a high gain.

According to the present invention as described above, it is possible to provide a radar apparatus that is capable of preventing a deterioration in reception sensitivity while broadening a detection range using a plurality of antenna elements.

### BRIEF DESCRIPTION OF THE DRAWINGS

FIG. 1(A) is a view illustrating the configuration of a radar apparatus according to Embodiment 1 of the present invention, and FIG. 1(B) is a view illustrating the configuration of a radar apparatus according to Embodiment 1 of the present invention;

FIG. 2 is a structure of an antenna element in a radar apparatus according to Embodiment 1 of the present invention;

FIG. 3 is a view showing a timing chart of a pulse generating circuit, a switching control circuit, and a switching element of the radar apparatus according to Embodiment 1 of the present invention;

FIG. 4 is a view illustrating the beam radiating directions in accordance with pulse generation timings of the radar apparatus according to Embodiment 1 of the present invention;

FIG. 5 includes two views relating to the radar apparatus according to Embodiment 1 of the present invention, in which (A) is a view that illustrates the directivity of a vertical (XZ) plane, and (B) is a view that illustrates the directivity of a conical plane where an elevation angle θ is 70 degrees;

FIG. 6 includes two views relating to the radar apparatus according to Embodiment 1 of the present invention, in which (A) is a view that illustrates the directivity of a vertical (XZ) plane, and (B) is a view that illustrates the directivity of a conical plane where an elevation angle θ is 70 degrees;

FIG. 7(A) is a configuration diagram of a radar apparatus according to Embodiment 2 of the present invention, FIG. 7(B) is a configuration diagram of the radar apparatus according to Embodiment 2 of the present invention, and FIG. 7(C) is a configuration diagram of a radar apparatus according to Embodiment 2 of the present invention;

FIG. 8 includes two views relating to the radar apparatus according to Embodiment 2 of the present invention, in which (A) is a view that illustrates the directivity of a vertical (XZ) plane, and (B) is a view that illustrates the directivity of a conical plane where an elevation angle θ is 50 degrees;

FIG. 9 includes two views relating to the radar apparatus according to Embodiment 2 of the present invention, in which (A) is a view that illustrates the directivity of a vertical (XZ) plane, and (B) is a view that illustrates the directivity of a conical plane where an elevation angle θ is 50 degrees;

FIG. 10(A) is a configuration diagram of a radar apparatus according to Embodiment 3 of the present invention, FIG. 10(B) is a configuration diagram of the radar apparatus according to Embodiment 3 of the present invention, and FIG. 10(C) is a configuration diagram of a radar apparatus according to Embodiment 3 of the present invention;

FIG. 11 includes two views relating to the radar apparatus according to Embodiment 3 of the present invention, in which (A) is a view that illustrates the directivity of a vertical (XZ) plane, and (B) is a view that illustrates the directivity of a conical plane where an elevation angle θ is 50 degrees;

FIG. 12 includes two views relating to the radar apparatus according to Embodiment 3 of the present invention, in which (A) is a view that illustrates the directivity of a vertical (XZ) plane, and (B) is a view that illustrates the directivity of a conical plane where an elevation angle θ is 50 degrees;

FIG. 13(A) is a configuration diagram of a radar apparatus according to Embodiment 4 of the present invention, FIG. 13(B) is a configuration diagram of the radar apparatus according to Embodiment 4 of the present invention, and FIG. 13(C) is a configuration diagram of a radar apparatus according to Embodiment 4 of the present invention;

FIG. 14 includes two views relating to the radar apparatus according to Embodiment 4 of the present invention, in which (A) is a view that illustrates the directivity of a vertical (XZ) plane, and (B) is a view that illustrates the directivity of a conical plane where an elevation angle θ is 50 degrees;

FIG. 15 includes two views relating to the radar apparatus according to Embodiment 4 of the present invention, in which (A) is a view that illustrates the directivity of a vertical (XZ) plane, and (B) is a view that illustrates the directivity of a conical plane where an elevation angle θ is 50 degrees;

FIG. 16(A) is a view illustrating the configuration of another configuration example of the radar apparatus according to Embodiment 1 of the present invention, and FIG. 16(B) is a view illustrating the configuration of another configuration example of the radar apparatus according to Embodiment 1 of the present invention;

FIG. 17 is a view illustrating a beam radiating direction according to a pulse generation timing of the other configuration example of the radar apparatus according to Embodiment 1 of the present invention; and

FIG. 18 is a view that shows a pulse generating circuit, a switching control circuit, and a switching element of the other configuration example of the radar apparatus according to Embodiment 1 of the present invention.

### DESCRIPTION OF SYMBOLS

101 transmitter
102 receiver
103, 104, 182, 183 switching element
105, 106, 181, 701, 702 antenna element
107 pulse generating circuit
108 oscillator
109 directional coupler
100, 150, 160, 170, 180 radar apparatus
110, 184 switching control circuit
111 mixer
112 signal processor
113a to 113d balun
120, 703 substrate
130, 190, 706 reflector
201a to 201d, 202a to 202d, 203a to 203d linear conducting element
204a, 204b, 205a, 205b linear coupling element
206, 207 linear detour element
401 vehicle
402, 403, 404 beam
721a to 721d, 722a to 722d, 723a to 723d slot element
724a, 724b, 725a, 725b slot coupling element
726a, 726b slot detour element
1301a to 1301c, 1302a to 1302c slot waveguide element
1303a to 1303c, 1304a to 1304c slot reflection
A, B, C, D, E, F, G, H, I, J power feeding point

### PREFERRED EMBODIMENTS OF THE INVENTION

Hereunder, a radar apparatus according to the embodiments of the present invention are described in detail with reference to the drawings. In each of the drawings, corresponding portions and components having the same function or configuration are assigned the same reference numerals and detailed explanations thereof are omitted. The following descriptions are made on the assumption that 26 GHz is taken as the operating frequency.

### Embodiment 1

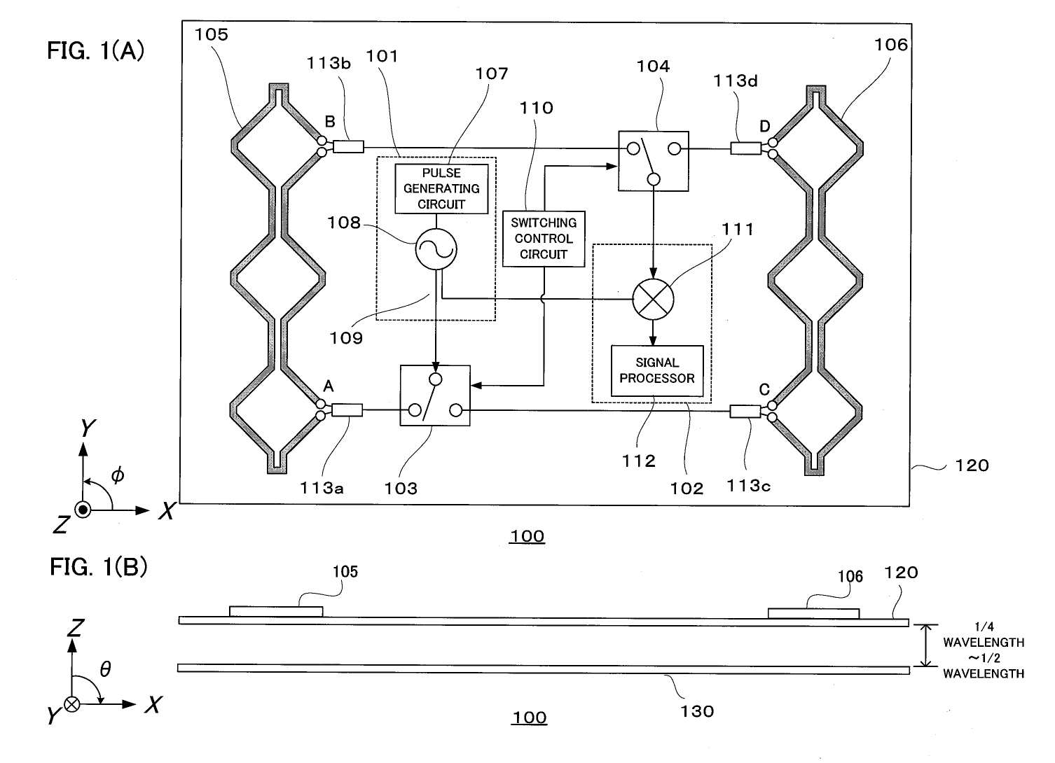

The radar apparatus according to Embodiment 1 of the present invention will be described using FIG. 1 to FIG. 5.

FIGS. 1(A) and 1(B) are views that illustrate a radar apparatus 100 that is capable of beam switching. As shown in FIG. 1(A), the radar apparatus 100 comprises a transmitter 101, a receiver 102, switching elements 103 and 104, antenna elements 105 and 106, and a reflector 130. The reflector 130 is formed of a metallic material, and as shown in FIG. 1(B), is disposed at a distance of ¼ wavelength to ½ wavelength in parallel with a plane on which antenna elements 105 and 106 are disposed in the −Z direction from a substrate 120 comprising each component shown in FIG. 1(A).

First, the detailed configuration and fundamental operations for transmitting and receiving of the radar apparatus 100 configured as show in FIG. 1 will be described. The transmitter 101 comprises a pulse generating circuit 107, an oscillator 108, and a directional coupler 109. The pulse generating circuit 107, for example, generates a 1-ns pulse signal. The oscillator 108 is driven by the generated pulse signal to oscillate a 26-GHz pulse signal. The directional coupler 109 outputs the 26-GHz pulse signal to the switching element 103, and also distributes it to the mixer 111 of the receiver 102. The switching element 103 is, for example, a SPDT switch comprising a PIN diode or an FET. The switching element 103 performs a switching operation so as to output a pulse signal that is output from the transmitter 101 by the switching control circuit 110 to either one of the antenna elements 105 and 106. A pulse signal is transmitted from the antenna element 105 or 106 that is connected with the transmitter 101.

The antenna element 105 or 106 is performed as receiving antenna to receive a pulse signal that is reflected from an obstacle. The mixer 111 of the receiver 102 mixes the receiving pulse signal inputted through the switch element 104 and the pulse signal that is distributed from the transmitter 101 to output as a beat signal to the signal processor 112. The switching element 104 is a SPDT switch comprising a PIN diode or an FET, similarly to the switching element 103. The signal processor 112 processes the inputted beat signal to calculate the distance to the obstacle based on the time difference from transmission of the pulse signal until receipt the pulse signal reflected.

Furthermore, the switching elements 103 and 104 selectively switches the connection between the antenna elements 105 and 106 and the transmitter 101 and the receiver 102. the detection range of radar apparatus 101 becomes the range in accordance with the directivity of each antenna element, the detection range or the detection direction are able to be freely set.

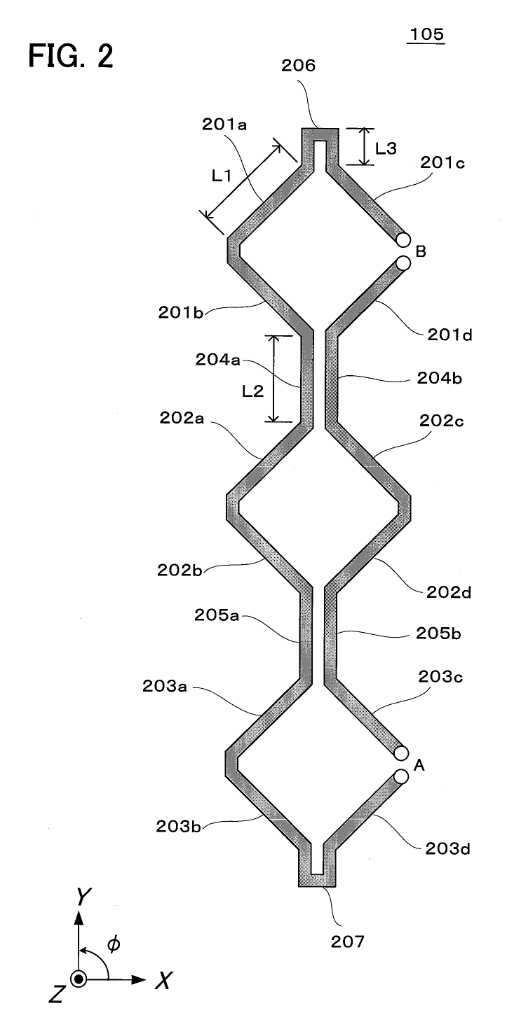

Next, the configuration of the antenna element 105 will be described using FIG. 2. Since the configuration of the antenna element 106 is the same as that of the antenna element 105, a description thereof is omitted. In FIG. 2, linear conducting elements 201a to 201d, 202a to 202d, and 203a to 203d are conductors formed in a straight-line shape with a length L1 that is approximately ⅓ of a wavelength and an element width of 0.2 mm. As shown in FIG. 2, these linear conducting elements are disposed so as to form a square shape by disposing the long sides in a condition in which they oppose each other at equal distances with respect to each set of the three sets of linear conducting elements 201a to 201d, linear conducting elements 202a to 202d, and linear conducting elements 203a to 203d. In this connection, although the configuration of the linear conducting elements adopted here is a square shape, the disposition of each set of linear conducting elements may be a diamond shape. Further, by configuring the linear conducting elements themselves as arc-shaped conductors, each set may be configured in a circular shape.

The area between the linear conducting elements 201c and 201d and the area between the linear conducting elements 203c and 203d is not connected, and are left open to allow a connection with the power feeding points A and B that are described later.

The linear coupling elements 204a and 204b, and 205a and 205b are conductors formed in a straight-line shape with a length L2 that is approximately ⅖ of a wavelength and an element width of 0.2 mm. The linear coupling element 204a links the linear conducting elements 201b and 202a, and the linear coupling element 204b links the linear conducting elements 201d and 202c. The linear coupling elements 205a and 205b link the linear conducting elements 202b and 203a, and the linear conducting elements 202d and 203c, respectively.

The linear detour elements 206 and 207 are conductors formed in a fold shape with a length L3 that is approximately ⅕ of a wavelength (total length is approximately ⅖ of a wavelength) and an element width of 0.2 mm. The linear detour element 206 is connected between the linear conducting elements 201a and 201c, and the linear detour element 207 is connected between the linear conducting elements 203b and 203d.

With the above described configuration, the linear conducting elements 201a to 201d, 202a to 202d, and 203a to 203d, the linear coupling elements 204a, 204b, 205a, and 205b, and the linear detour elements 206 and 207 link up diamond-shaped antenna elements (diamond-shaped antenna portions) to comprise the antenna element 105 having an array configuration.

In this connection, in the above described configurations, the antenna elements 105 and 106 correspond to an antenna element of the present invention. Further, the transmitter 101 corresponds to the transmitter of the present invention and the receiver 102 corresponds to the receiver of the present invention. The switching element 103 corresponds to a first antenna switching portion of the present invention and the switching element 104 corresponds to a second antenna switching portion of the present invention. The switching control circuit 110 corresponds to a control portion of the present invention.

Further, the linear conducting elements 201a to 201d, 202a to 202d, and 203a to 203d correspond to first to fourth linear conducting elements of the present invention, respectively, and comprise a diamond-shaped antenna portion of the present invention. The linear coupling elements 204a, 204b, 205a, and 205b correspond to a linear coupling element of the present invention, and the linear detour elements 206 and 207 correspond to a linear detour element of the present invention.

Further, the power feeding point A and the power feeding point C correspond to a first power feeding point of the present invention, and the power feeding point B and the power feeding point D correspond to a second power feeding point of the present invention.

Next, an operation to excite the antenna element 105 from the power feeding points A and B will be described with reference to FIG. 1(A) and FIG. 2.

The power feeding point A is connected to the linear conducting elements 203c and 203d, and is connected to the switching element 103 through a balun 113a. The power feeding point B is connected to the linear conducting elements 201c and 201d, and is connected to the switching element 104 through a balun 113b. When exciting the antenna element 105 from the power feeding point A, the power feeding point B is, for example, short circuited using a switching element such as a PIN diode to connect the linear conducting elements 201c and 201d.

At this time, the antenna element 105 operates as a loop antenna element, and at the respective connection portions of the linear conducting elements 201a and 201b, linear conducting elements 201c and 201d, linear conducting elements 202a and 202b, linear conducting elements 202c and 202d, linear conducting elements 203a and 203b, and linear conducting elements 203c and 203d, the electrical current amplitude is a peak value. Further, the electrical current phases φ1 at the connection portions of the linear conducting elements 201a and 201b, linear conducting elements 202a and 202b, and linear conducting elements 203a and 203b are in phase, and the electrical current phases φ2 at the connection portions of the linear conducting elements 201c and 201d, linear conducting elements 202c and 202d, and linear conducting elements 203c and 203d are in phase. Since a phase difference arises between the electrical current phases φ1 and φ2 because the linear detour elements 206 and 207 are inserted, the main beam direction of the antenna element 105 inclines from the +Z direction to the −X direction. At this time, as shown in FIG. 1(B), since the reflector 130 is disposed at a distance of a predetermined space on the −Z direction side with respect to the surface of the antenna element 105, the main beam is formed so as to radiate only to the +Z side.

Further, when exciting the antenna element 105 from the power feeding point B, similarly to the case of exciting from the power feeding point A as described above, the main beam direction of the antenna element 105 inclines from the +Z direction to the −X direction.

In contrast, when exciting the antenna element 106 from the power feeding point C or D, in either case the main beam direction of the antenna element 106 inclines from the +Z direction to the +X direction.

More specifically, since the main beam direction is the same irrespective of which of the two power feeding points that the antenna elements 105 and 106 are excited from, as shown in FIG. 1(A), by disposing the antenna elements 105 and 106 so that the respective power feeding points thereof oppose each other, the main beam directions of the respective antenna elements incline in different directions (the +X direction and −X direction shown in FIG. 1).

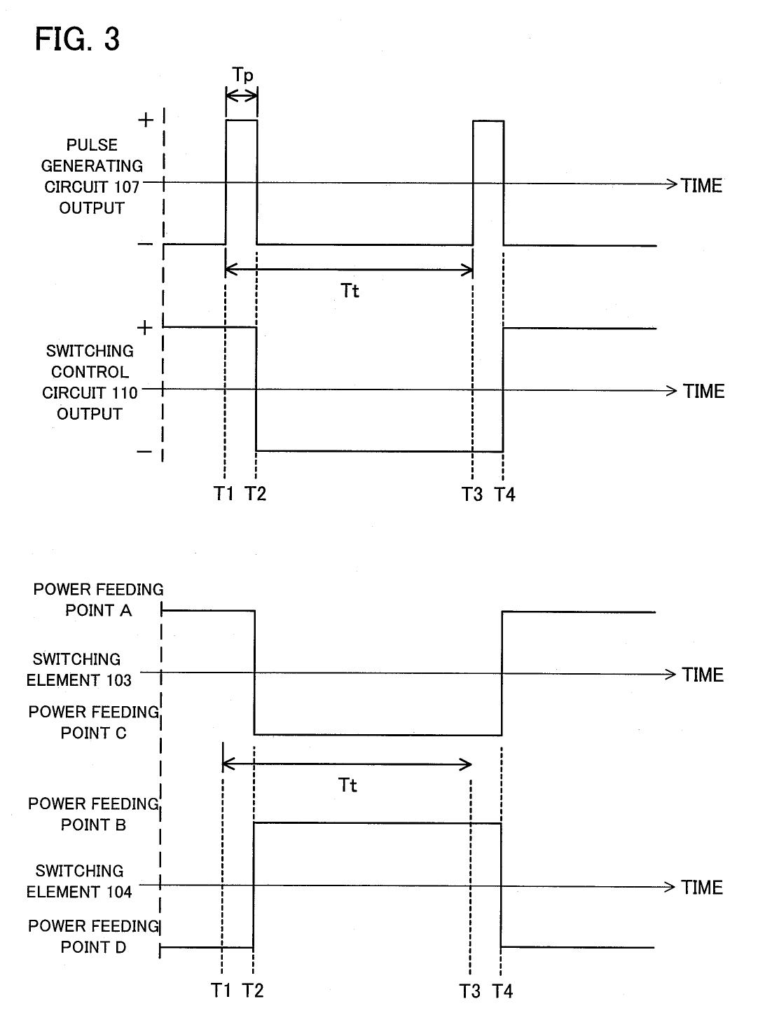

A beam switching operation in the radar apparatus 100 configured as described above will now be described using the timing chart shown in FIG. 3. First, a radar operation in one period from a time T1 to a time T3 shown in FIG. 3 will be described.

From the time T1, the pulse generating circuit 107 of the transmitter 101 generates, for example, a pulse signal for which a pulse width Tp=0.5 ns to 1 ns at intervals of a period Tt=100 ns to 10 μs. The numerical values described here represent one example, and by shortening the pulse width Tp it is possible to improve resolution in a case in which there are a plurality of obstacles to perform highly precise discrimination. Further, by shortening the period Tt, since a large amount of reception data can be accumulated during a system update period, an improvement in reception sensitivity produced by signal processing and the like can be anticipated. The pulse width Tp and the period Tt may be selected in accordance with the system requirements specification.

At this time, the switching element 103 is controlled by the switching control circuit 110, and switching operations are performed so that the switching element 103 is connected to the power feeding point A of the antenna element 105 when the control voltage is positive (+) and connected to the power feeding point C of the antenna element 106 when the control voltage is negative (−).

The output of the switching control circuit 110 is controlled to change from positive (+) to negative (−) directly after a pulse signal of the pulse width Tp is transmitted from the pulse generating circuit 107, i.e. at a time T2.

As shown in FIG. 3, because the control voltage is positive (+) during the period from time T1 to time T2 in which a pulse signal is generated, a 26-GHz pulse signal that is output from the transmitter 101 is output to the power feeding point A of the antenna element 105 so that the antenna element 105 is excited. Here, a description regarding a delay time from the pulse generating circuit 107 to the switching element 103 is ignored to simplify the description.

Meanwhile, similarly to the switching element 103, the switching element 104 is also controlled by the switching control circuit 110, and switching operations are performed so that the switching element 104 is connected to the power feeding point B of the antenna element 105 when the control voltage is negative (−) and connected to the power feeding point D of the antenna element 106 when the control voltage is positive (+). Therefore, because the control voltage is positive (+) during the period from the time T1 to the time T2 when a pulse signal is generated, the switching element 104 is connected to the power feeding point D of the antenna element 106. More specifically, the antenna element 106 is connected to the receiver 102.

By short-circuiting a terminal on the power feeding point B side of the antenna element 105 of the switching element 104 and setting a length as far as the power feeding point B to an integral multiple of a ½ wavelength, for example, a state can be achieved that is equivalent to a state in which the power feeding point B is short-circuited. As a result, the antenna element 105 can incline the main beam direction from the +Z direction to the −X direction as described above without receiving he influence of the switching element 104 even when the switching element 104 is connected.

As described above, simultaneously with transmission of a pulse signal from the antenna element 105, that is, simultaneously with reaching the time T2, the control voltage of the switching control circuit 110 becomes negative (−). Thereby, the switching element 103 is connected to the power feeding point C of the antenna element 106, and the switching element 104 is connected to the power feeding point B of the antenna element 105. More specifically, the antenna element 105 is connected to the receiver 102 and the antenna element 106 is connected to the transmitter 101.

Immediately after a pulse signal is transmitted from the antenna element 105 in this manner, by connecting the antenna element 105 to the mixer 111 through the switching element 104 it is possible to receive reflection waves that are reflected from obstacles at a short distance, to thereby enable short-distance detection. At this time, similarly to the switching element 103 when transmitting a pulse signal from the antenna element 105, by short-circuiting a terminal on the power feeding point A side of the switching element 103 and setting a length as far as the power feeding point A to an integral multiple of a ½ wavelength, the influence of the switching element 103 can be reduced.

As described above, by connecting the antenna element 105 to the transmitter 101 in a period from the time T1 to the time T2, and connecting the antenna element 105 to the receiver 102 in the period after time T2, transmitting and receiving operations are performed on a time-division basis.

With respect to a period after a time T3 shown in FIG. 3 also, the antenna elements 105 and 106 and the switching elements 103 and 104 are controlled by the switching control circuit 110 in a similar manner to the above described operations. That is, switching operations are performed so as to connect the switching elements 103 and 104 to the power feeding point A of the antenna element 105 and the power feeding point D of the antenna element 106 when the control voltage is positive (+), and to the power feeding point C of the antenna element 106 and the power feeding point B of the antenna element 105 when the control voltage is negative (−).

More specifically, switching operations are performed so that the antenna element 106 is connected to the receiver 102 when the antenna element 105 is connected to the transmitter 101, and the antenna element 105 is connected to the receiver 102 when the antenna element 106 is connected to the transmitter 101.

In the case of FIG. 3, although the antenna element 106 does not function as a radar since it is connected to the receiver 102 in the period from the time T1 that is the operation start time of the radar apparatus 100 until T2, since during the period from the time T2 to T4 the transmitter 101 and the power feeding point C are connected by the switching element 103 and from the time T3 until T4 input of a pulse signal is received from the pulse generating circuit 107, similarly to the antenna element 105, after the time difference of period Tt, transmitting and receiving operations start on a time-division basis.

Accordingly, if the antenna elements 105 and 106 are disposed so that the directivity of each is different, transmitting and receiving operations are performed in which the beam direction of each antenna is alternately switched to thereby enable the detection range to be broadened with respect to the apparatus overall.

As described above, according to the radar apparatus 100 of the present Embodiment 1, by adopting a configuration in which independent power feeding points are provided for transmission and for receiving with respect to each of the antenna elements 105 and 106 that have mutually different directivity and controlling the switching timing of the switching elements 103 and 104 and the pulse generation timing of the pulse generating circuit 107, transmitting and receiving operations are performed on a time-division basis so that for the antenna element 105 and the antenna element 106, the timings of transmitting and receiving are alternately transposed, respectively. Since isolation during transmitting and receiving can be ensured by providing independent power feeding points for transmitting and for receiving, the antenna element 105 and the antenna element 106 can be respectively used as a shared antenna for transmitting and receiving without using a shared device such as a circulator.

It is thereby possible to reduce the loss caused by a circulator that has been conventionally required, and improve the reception sensitivity while broadening the detection range.

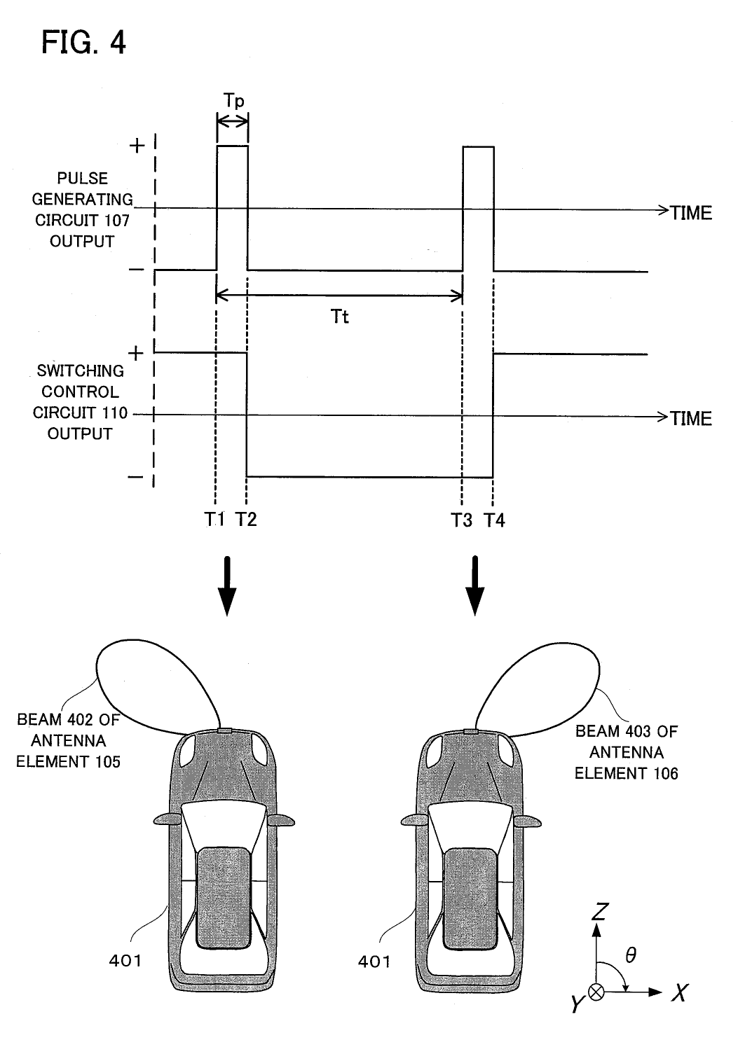

The manner in which the beam radiating directions change in accordance with the timing chart shown in FIG. 3 will now be described using FIG. 4. FIG. 4 is a view that shows a state when a vehicle 401 having the radar apparatus 100 mounted at the front of the vehicle is viewed from directly overhead, for which it is assumed that the antenna beams are emitted in accordance with the aforementioned timing chart. The coordinate axes in FIG. 4 correspond to the coordinate axes of the radar apparatus 100 shown in FIG. 1(B), and it is assumed that the antenna beam is emitted in the X-axis direction.

First, since the radar apparatus 100 transmits a pulse signal through the antenna element 105 that is connected to the transmitter 101 through the power feeding point A at a pulse generation timing from the time T1 to T2, a beam 402 that inclines in the −X direction is emitted. From the time T2 to T3, the control voltage of the switching control circuit 110 is negative (−) and the antenna element 105 is connected to the receiver 102 through the power feeding point B and receives a reflected signal of the pulse signal that is transmitted previously.

Similarly, since the radar apparatus 100 transmits a pulse signal through the antenna element 106 that is connected to the transmitter 101 through the power feeding point C at a pulse generation timing from the time T3 to T4, a beam 403 that inclines in the +X direction is emitted. After the time T4, until the next pulse generation timing the control voltage of the switching control circuit 110 is negative (−) and the antenna element 106 is connected to the receiver 102 through the power feeding point D and receives a reflected signal of the pulse signal that is transmitted previously.

Thus, by switching the beam direction of the radar apparatus 100 in accordance with the pulse generation timing, it is possible to switch the detection direction and obtain a wide detection range.

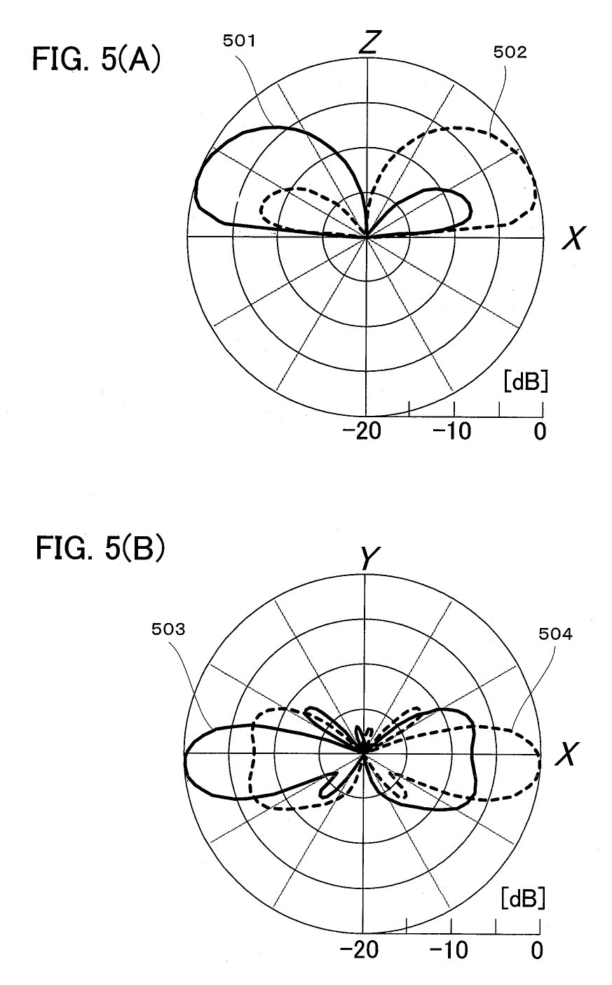

Next, the situation relating to the directivity of the antenna elements 105 and 106 is described in detail. FIG. 5 includes a view that illustrates the directivity in a case in which the antenna element 105 is excited from the power feeding point A and a view that illustrates the directivity in a case in which the antenna element 106 is excited from the power feeding point C, in which FIG. 5(A) is a view that illustrates the directivity of a vertical (XZ) plane and FIG. 5(B) is a view that illustrates the directivity of a conical plane where an elevation angle θ is 70 degrees. In FIG. 5, directivities 501 and 503 indicate the directivity of a horizontally polarized wave Eφ component when the antenna element 105 is excited from the power feeding point A, and it can be confirmed that the main beam is oriented in the −X direction. At this time, the directivity gain of the main beam is 13.2 dBi.

Further, the directivities 502 and 504 indicate the directivity of a horizontally polarized wave Eφ component when the antenna element 106 is excited from the power feeding point C, and it can be confirmed that the main beam is oriented in the +X direction.

Thus, the main beam direction can be switched in two directions by switching excitation for the antenna elements 105 and 106, and the detection direction can be switched.

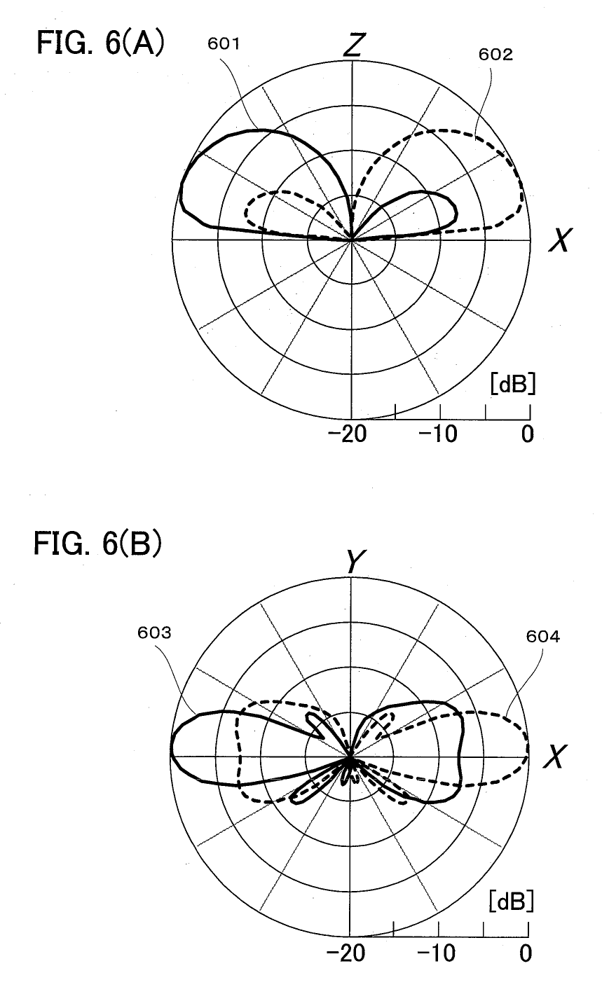

FIG. 6 includes a view that illustrates the directivity in a case in which the antenna element 105 is excited from the power feeding point B and a view that illustrates the directivity in a case in which the antenna element 106 is excited from the power feeding point D, in which FIG. 6(A) is a view that illustrates the directivity of a vertical (XZ) plane and FIG. 6(B) is a view that illustrates the directivity of a conical plane where an elevation angle θ is 70 degrees.

In FIG. 6, directivities 601 and 603 indicate the directivity of a horizontally polarized wave Eφ component when the antenna element 105 is excited from the power feeding point B, and directivities 602 and 604 indicate the directivity of a horizontally polarized wave Eφ component when the antenna element 106 is excited from the power feeding point D.

Thus, by mounting the above described radar apparatus 100 inside the bumper of an automobile so as to dispose the −Y direction shown in FIG. 1 on the ground side, for example, since the main beam can be switched in the horizontal direction, the detection range can be broadened with a single radar apparatus 100.

As described above, according to the radar apparatus 100 of the present embodiment, antenna elements 105 and 106 comprise two power feeding points through which the same directivity is obtained in a case in which either thereof is used to excite the antenna element in question, and the antenna elements 105 and 106 are disposed so as to have a different directivity to each other. Thus, by performing transmitting and receiving on a time-division basis by regulating the timing of pulse generation and switching of switching elements 103 and 104, a configuration is realized in which the transmitter 101 and the receiver 102 operate by sharing a single antenna element.

Therefore, a shared device such as a circulator that has been required heretofore to allow a transmitter and a receiver to share an antenna element is unnecessary, the reception sensitivity is enhanced since loss at a shared device can be reduced, and the radar apparatus 100 with a planar structure can be realized at a low cost.

### Embodiment 2

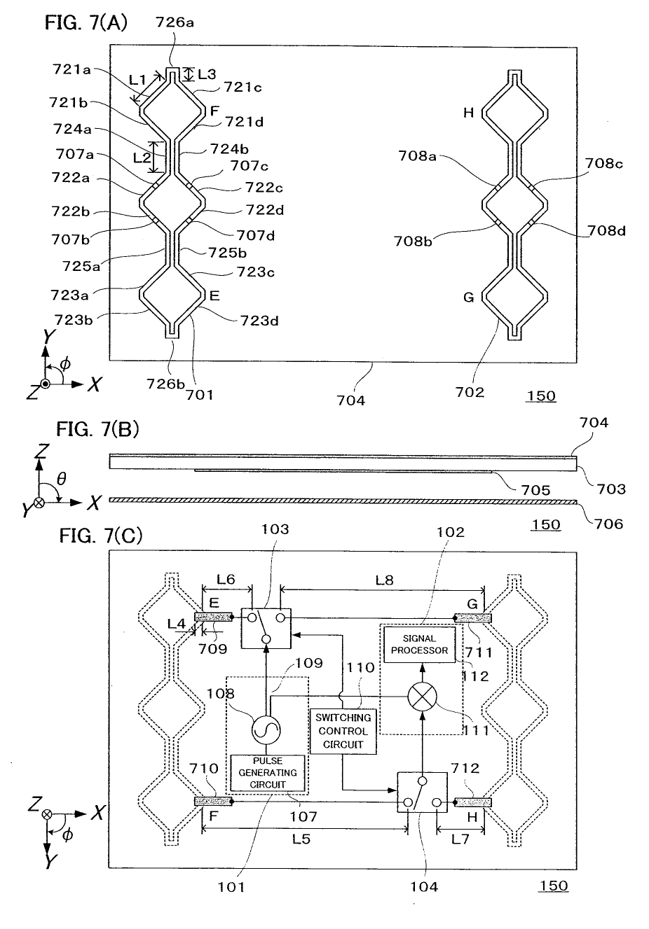

A radar apparatus according to Embodiment 2 of the present invention will now be described using FIG. 7 to FIG. 9.

In the radar apparatus according to the present Embodiment 2, the configuration for controlling transmission and reception is the same as that of Embodiment 1. A feature of the radar apparatus according to the present Embodiment 2 is that the structure of the antenna elements is different. Accordingly, the same reference numerals are assigned to the same or corresponding parts, and detailed explanations thereof are omitted.

FIGS. 7(A), 7(B), and 7(C) are views that illustrate the configuration of a radar apparatus, similarly to Embodiment 1. As shown in the figures, a radar apparatus 150 according to the present embodiment comprises a transmitter 101, a receiver 102, switching elements 103 and 104, and antenna elements 701 and 702.

In FIG. 7(A), the antenna elements 701 and 702 are slot antenna elements that are formed by cutting a conductor layer 704. Similarly to the antenna elements 105 and 106 of Embodiment 1, a configuration is adopted in which diamond-shaped slot antenna elements (hereunder, referred to as “diamond-shaped slot antenna portion”) are linked. In FIG. 7(A), reference numerals 721a to 721d, 722a to 722d, and 723a to 723d denote linear shaped slot elements, reference numerals 724a, 724b, 725a, and 725b denote linear shaped slot coupling elements, and reference numerals 726a and 726b denote fold shaped slot detour elements.

The slot elements 721a to 721d, 722a to 722d, and 723a to 723d have a shape that corresponds to the linear conducting elements 201a to 201d, 202a to 202d, and 203a to 203d of the antenna element 105 of Embodiment 1. Likewise, the slot coupling elements 724a, 724b, 725a, and 725b have a shape that corresponds to the linear coupling elements 204a, 204b, 205a, and 205b, and the slot detour elements 726a and 726b have a shape corresponding to the linear detour elements 206 and 207.

However, unlike Embodiment 1, a configuration is adopted in which slots are made to communicate between the slot elements 721c and 721d and the slot elements 723c and 723d.

A substrate 703 is, for example, a dielectric material with a thickness of 0.26 mm for which a dielectric constant ∈r is 3.45. The conductor layer 704 is a copper foil that is adhered to the +Z side surface of the substrate 703.

As shown in FIG. 7(C), in the conductor layer 705, the switching elements 103 and 104 and the transmitter 101 and the receiver 102 composed, for example, by a microstrip line are formed between the antenna elements 701 and 702. Further, as shown in FIG. 7(B), a reflector 706 is disposed at a position that is separated on the −Z side by the amount of, for example, 0.43 wavelengths from the surface on which the antenna elements 701 and 702 are disposed.

Referring again to FIG. 7(A), connection conductors 707a to 707d and 708a to 708d are formed, for example, with copper foil on the same surface as the conductor layer 704, and connect an inner conductor layer and outer conductor layer of the antenna elements 701 and 702 so as to segment each slot at substantially the center of each side of the diamond-shaped slot antenna portions that are disposed in the center of the antenna elements 701 and 702.

By segmenting the slot by means of the connection conductors 707a to 707d and 708a to 708d in this manner, the amplitude and phase of a magnetic field that is distributed on a slot is regulated and a phase difference is generated by insertion of the slot detour elements 726a and 726b, such that the main beam of the antenna element 701 is formed from the +Z direction to the −X direction and the main beam of the antenna element 702 is formed from the +Z direction to the +X direction.

In this connection, the number of connection conductors 707a to 707d and 708a to 708d is not limited as long as they are provided as vertically-disposed symmetry when viewed from the rows of the antenna elements 701 and 702. Although the connection conductors are only provided in the center in the example shown in FIG. 7, a configuration may also be adopted in which connection conductors are provided in diamond-shaped slot antenna portions in which power feeding points E and F are respectively provided.

Further, a configuration may also be adopted in which the phase difference or frequency is adjusted by adjusting the positions of connection conductors.

As shown in FIG. 7(C), microstrip lines 709 to 712 are formed with copper foil on the −Z side surface of the substrate 703. Microstrip lines 709 and 710 are formed along the X direction so as to pass through each of power feeding points E and F at the top of the antenna element 701, and are connected to switching elements 103 and 104, respectively. Microstrip lines 711 and 712 are formed along the X direction so as to pass through each of power feeding points G and H of the diamond-shaped slot antenna portion of the antenna element 702, and are connected to switching elements 103 and 104, respectively. The microstrip lines 709 to 712, for examples, have a width of 0.6 mm and the characteristic impedance thereof is set to 50Ω. Further, the respective distances L4 between the tip of each of the microstrip lines 709 to 712 and the power feeding points E to H at the tops of the slot elements are, for example, set as 2 mm.

By adopting the above described configuration, because the microstrip lines 709 and 710 are electromagnetically coupled with the antenna element 701 and the microstrip lines 711 and 712 are electromagnetically coupled with the antenna element 702, a transmission signal that is output from the transmitter 101 is supplied through the switching element 103 to the antenna element 701 or 702, and a reception signal that is received by the antenna element 701 or 702 is input to the receiver 102 through the switching element 104. At this time, impedance matching can be achieved by setting the distances L4 to an appropriate length. Thus, the power supply from the transmitter 101 or the receiver 102 that comprises a microstrip line is facilitated and productivity can be enhanced.

In the above described configuration, the slot elements 721a to 721d, 722a to 722d and 723a to 723d respectively correspond to the first to fourth linear slots of the present invention, and comprise diamond-shaped antenna slots of the present invention. The slot coupling elements 724a, 724b, 725a, and 725b correspond to linear coupling slots of the present invention and the slot detour elements 726a and 726b correspond to linear detour slots of the present invention. Each of these slots constitutes an array antenna slot of the present invention. Further, the connection conductors 707a to 707d and 708a to 708d correspond to connection conductors of the present invention, and antenna elements 701 and 702 including the conductor layer 704 and the dielectric substrate 703 in which each slot is formed correspond to an antenna element of the present invention.

Next, the operations when transmitting and receiving will be described. A transmission pulse signal output from the transmitter 101 is transmitted from the antenna element 701 through the switching element 103 and the microstrip line 709. At this time, in order to prevent the characteristics of the antenna element 701 being degraded by the influence of the microstrip line 710 that is connected to the switching element 104, an operation is performed to disconnect the switching element 104 and the microstrip line 710. For example, when the impedance when the switching element 104 is in an off state is a short circuit, the influence of the microstrip line 710 can be eliminated by making a length L5 from the switching element 104 to the microstrip line 710 an odd-number multiple of ¼ wavelength. Further, when the impedance when the switching element 104 is in an off state is an open circuit, the influence of the microstrip line 710 can be eliminated by making the length L5 an even-number multiple of ½ wavelength.

Further, the switching elements 103 and 104 are controlled by the switching control circuit 110 as indicated in the timing chart shown in FIG. 3 in the same manner as in Embodiment 1, and immediately after transmission of a transmission pulse signal the switching element 103 is switched to connect to the microstrip line 711 from the microstrip line 709, and the switching element 104 is switched to connect to the microstrip line 710 from the microstrip line 712. Accordingly, while on one hand the antenna element 701 enters a receiving state, the antenna element 702 transmits a pulse signal in accordance with the timing of the pulse generating circuit 107.

At this time, similarly to a time of transmitting, in order to prevent the microstrip line of the transmission side influencing the characteristics of the antenna element 701, when the impedance when the switching element 103 is in an off state is a short circuit a length L6 from the switching element 103 to the microstrip line 709 is set to an odd-number multiple of ¼ wavelength.

Similarly to the above description, when transmitting from the antenna element 702, in order to prevent the microstrip lines 711 and 712 from influencing the characteristics of the antenna element 702, respective lengths length L7 and L8 from the switching elements 104 and 103 are set as indicated in the above description.

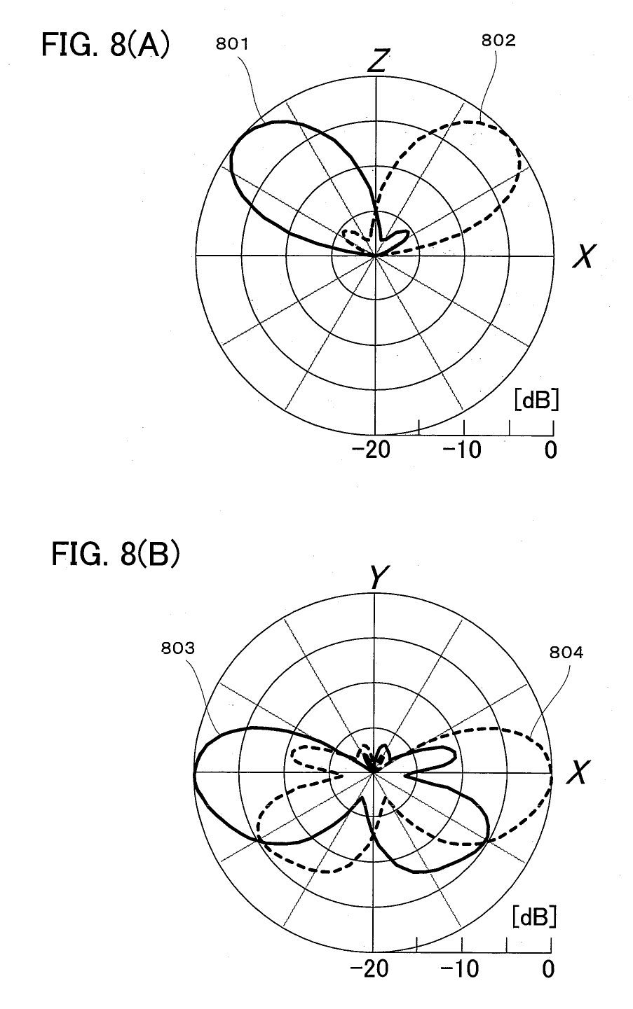

Next, the directivity of the antenna elements 701 and 702 that are configured as described above is described. FIG. 8 includes two views that illustrate the directivity when the antenna element 701 is excited from the power feeding point E by the microstrip line 709 and the directivity when the antenna element 702 is excited from the power feeding point G by the microstrip line 711, in which FIG. 8(A) is a view that illustrates the directivity of a vertical (XZ) plane, and FIG. 8(B) is a view that illustrates the directivity of a conical plane where an elevation angle θ is 50 degrees. In this case, the respective lengths L5 and L7 of the microstrip lines 710 and 712 from the switching element 104 are ¼ wavelength and the ends are set to a short circuit.

In FIG. 8, directivities 801 and 803 indicate the directivity of a vertically polarized wave Eθcomponent when the antenna element 701 is excited from the power feeding point E, and it can be confirmed that the main beam is oriented in the −X direction. At this time, the directivity gain of the main beam is 13 dBi.

Further, the directivities 802 and 804 indicate the directivity of a vertically polarized wave Eθ component when the antenna element 702 is excited from the power feeding point G, and it can be confirmed that the main beam is oriented in the +X direction.

Thus, the main beam direction can be switched in two directions by performing transmission and reception alternately by switching the antenna elements 701 and 702 and thereby broaden the detection range.

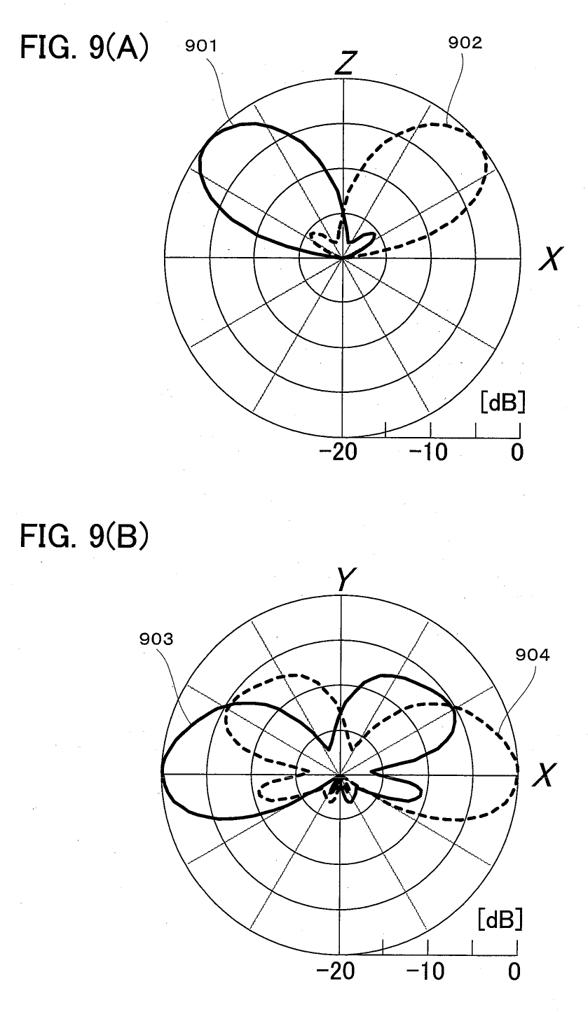

FIG. 9 includes two views that illustrate the directivity when the antenna element 701 is excited from the power feeding point F by the microstrip line 710 and the directivity when the antenna element 702 is excited from the power feeding point H by the microstrip line 712, in which FIG. 9(A) is a view that illustrates the directivity of a vertical (XZ) plane, and FIG. 9(B) is a view that illustrates the directivity of a conical plane where an elevation angle θ is 50 degrees. In this case, the respective lengths L6 and L8 of the microstrip lines 709 and 711 are ¼ wavelength and the ends are set to a short circuit.

In FIG. 9, directivities 901 and 903 indicate the directivity of a vertically polarized wave Eθcomponent when the antenna element 701 is excited from the power feeding point F, and directivities 902 and 904 indicate the directivity of a vertically polarized wave Eθ component when the antenna element 702 is excited from the power feeding point H.

As described above, according to the radar apparatus 150 of the present embodiment, by carrying out transmission and reception on a time-division basis by adjusting the timing of pulse generation and switching of the switching element 103 and 104, similarly to Embodiment 1, using the antenna elements 701 and 702 that are configured by providing slot elements on the surface of the dielectric substrate 703, a configuration is realized in which the transmitter 101 and the receiver 102 operate by sharing a single antenna element. Thus, a shared device such as a circulator is unnecessary, and it is therefore possible to realize the radar apparatus 150 with a planar structure at a low cost in which reception sensitivity is enhanced by decreasing a loss.

Further, the antenna elements 701 and 702 of the present embodiment can be easily excited using the microstrip lines 709 to 712 that are disposed on the rear surface of the dielectric substrate 703, and impedance matching is enabled by simply changing the microstrip line lengths.

Although according to the present embodiment each slot element is formed using a copper foil pattern on the dielectric substrate 703, a similar effect can be obtained by, for example, forming each slot element by providing a hollow in the conductor layer 704.

Further, although according to the present embodiment the connection conductors 707a to 707d and 708a to 708d are formed with a copper foil pattern inside each slot element and connect an outside conductor layer with an inside conductor layer of the slot elements so as to segment the slot element at approximately the center thereof, a similar effect can be obtained by forming the connection conductors 707a to 707d and 708a to 708d on the same plane surface as the microstrip lines 709 to 712 and connecting an outside conductor layer with an inside conductor layer through a through hole.

Further, the shape or arrangement of each slot element may be changed in a similar manner as in Embodiment 1, and the arrangement of the slot elements 721a to 721d, 722a to 722d, and 723a to 723d of each diamond-shaped slot antenna portion may be a diamond shape. Furthermore, a circular slot antenna portion in which the external shape is circular may be configured by configuring the slot elements themselves as conductors having arc-shaped slots.

### Embodiment 3

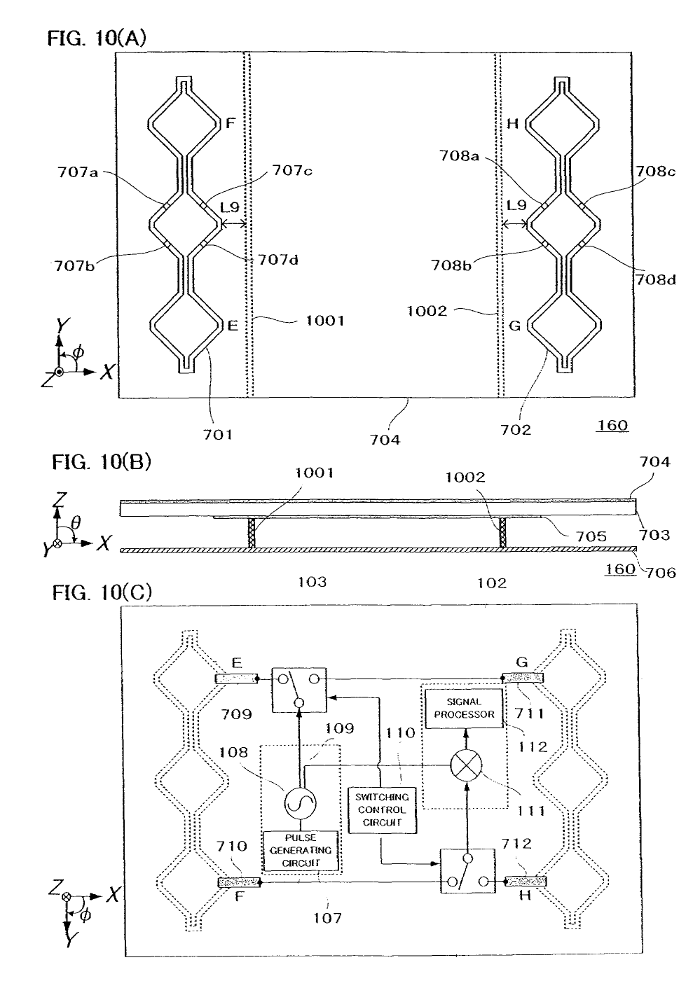

The radar apparatus according to Embodiment 3 of the present invention will now be described using FIG. 10 to FIG. 12. However, parts that correspond to or are the same as parts in Embodiment 1 and 2 are assigned the same reference numerals and detailed explanations thereof are omitted.

FIGS. 10(A), (B), and (C) are views that illustrate a radar apparatus 160 of the present embodiment having a configuration in which conductor plates 1001 and 1002 are added to the configuration of Embodiment 2. The conductor plate 1001 is disposed between the reflector 706 and the substrate 703 perpendicular to the antenna element surface at a clearance of a distance L9 on the +X direction side from the antenna element 701, more specifically, on the opposite side to the main beam direction. The conductor plate 1002 is disposed between the reflector 706 and the substrate 703 perpendicular to the antenna element surface at a clearance of a distance L9 on the −X direction side from the antenna element. In this case, for example, the distance L9 is set to 2.2 mm. Further, the conductor plates 1001 and 1002 are cut at the positions of the microstrip lines 709 to 712 so that no influence is imparted to transmission and reception signals.

According to the above configuration, a radio wave that is emitted to the −Z side from the antenna element 701 cannot propagate in the +X direction since it is obstructed by the conductor plate 1001. Likewise, a radio wave that is emitted to the −Z side from the antenna element 702 cannot propagate in the −X direction since it is obstructed by the conductor plate 1002. Therefore, radio waves from the antenna elements 701 and 702 are mainly emitted in the −X direction and +X direction, respectively, thereby improving the F/B ratio.

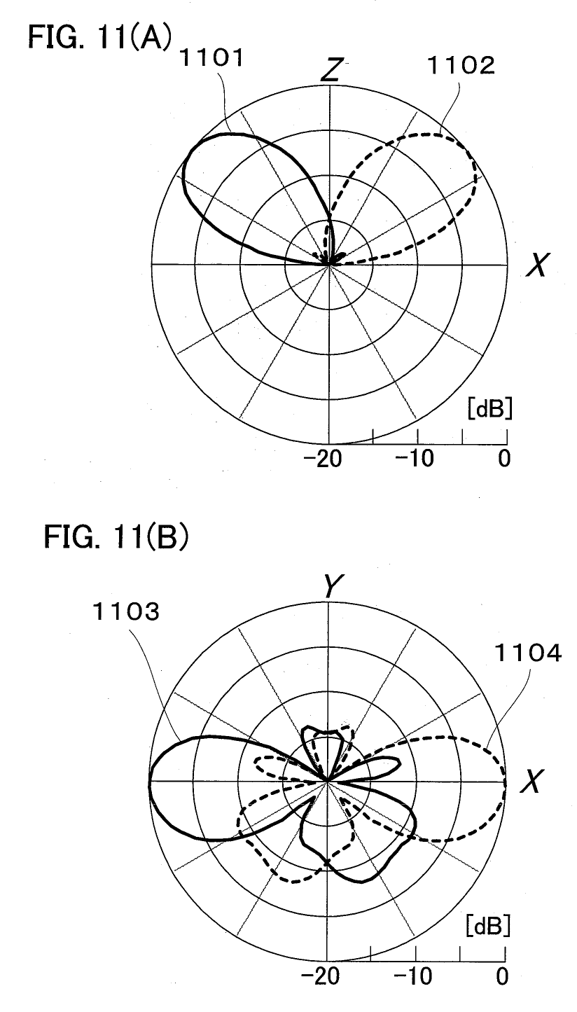

FIG. 11 includes two views illustrating the directivity when the antenna element 701 shown in FIG. 10 is excited from the power feeding point E by the microstrip line 709 and the directivity when the antenna element 702 shown in FIG. 10 is excited from the power feeding point G by the microstrip line 711, in which FIG. 11(A) is a view that illustrates the directivity of a vertical (XZ) plane, and FIG. 11(B) is a view that illustrates the directivity of a conical plane where an elevation angle θ is 50 degrees.

In FIG. 11, directivities 1101 and 1103 indicate the directivity of a vertically polarized wave Eθ component when the antenna element 701 is excited from the power feeding point E, and it can be confirmed that the main beam is oriented in the −X direction. At this time, the directivity gain of the main beam is 13.3 dBi.

Further, directivities 1102 and 1104 indicate the directivity of a vertically polarized wave Eθ component when the antenna element 702 is excited from the power feeding point G, and it can be confirmed that the main beam is oriented in the +X direction. Thus, the main beam direction can be switched in two directions by switching excitation for the antenna elements 701 and 702, and the detection range can be switched. Further, by comparing the directivities shown in FIG. 11(B) and in FIG. 8(B), it can be confirmed that the back lobe can be reduced and the F/B ratio improved by inserting the conductor plates 1001 and 1002.

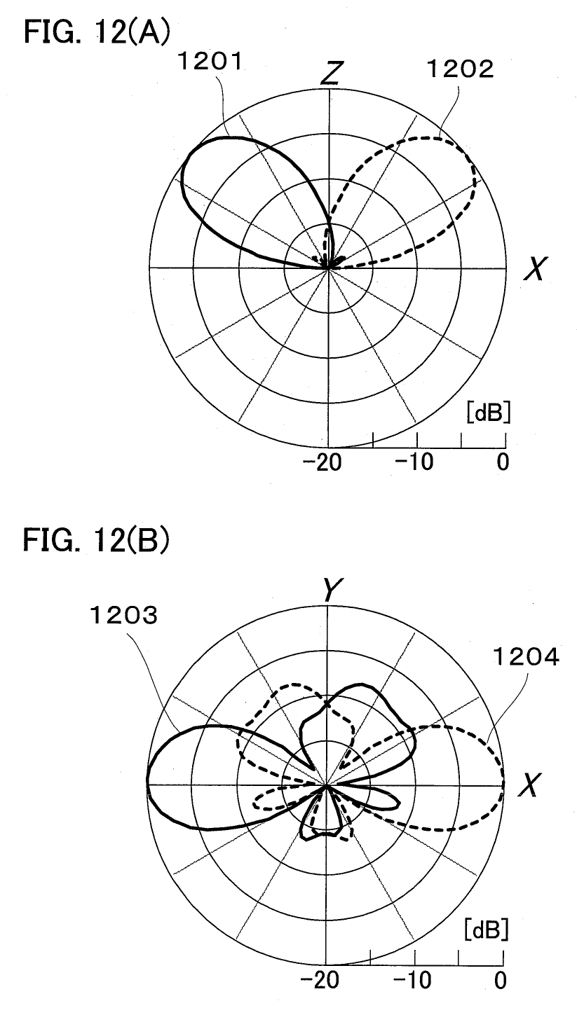

FIG. 12 includes two views illustrating the directivity when the antenna element 701 is excited from the power feeding point F by the microstrip line 710 and the directivity when the antenna element 702 is excited from the power feeding point H by the microstrip line 712, in which FIG. 12(A) is a view that illustrates the directivity of a vertical (XZ) plane, and FIG. 12(B) is a view that illustrates the directivity of a conical plane where an elevation angle θ is 50 degrees.

In FIG. 12, directivities 1201 and 1203 indicate the directivity of a vertically polarized wave Eθ component when the antenna element 701 is excited from the power feeding point F, and directivities 1202 and 1204 indicate the directivity of a vertically polarized wave Eθ component when the antenna element 702 is excited from the power feeding point H. Similarly to the case shown in FIG. 11, it can be confirmed that the F/B ratio is enhanced in comparison to the case shown in FIG. 9(B).

As described above, according to the radar apparatus 160 of the present embodiment, by disposing conductor plates 1001 and 1002 perpendicular to the antenna element surface between the dielectric substrate 703 and the reflector 706 with a predetermined space therebetween on the side opposite the main beam direction of the antenna elements 701 and 702, a radar apparatus having directivity with a good F/B ratio can be realized. It is therefore possible to decrease the reception level of radio waves that are reflected back from obstacles other than those in the main beam direction and improve the detection accuracy.

### Embodiment 4

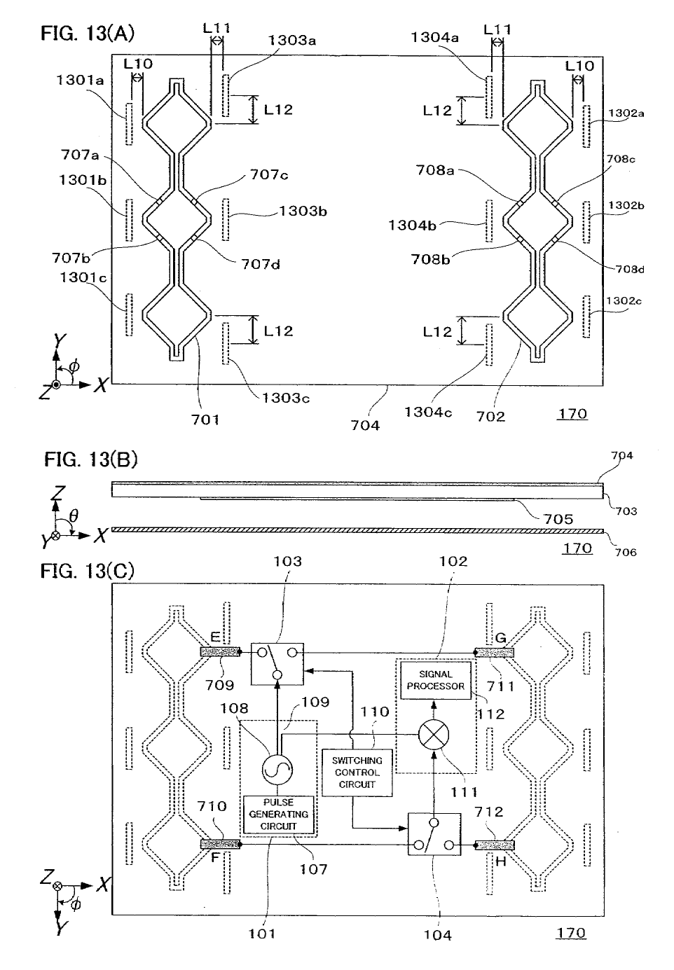

The radar apparatus according to Embodiment 4 of the present invention will now be described using FIG. 13 to FIG. 15. However, parts that correspond to or are the same as parts in Embodiment 1 and 2 are assigned the same reference numerals and detailed explanations thereof are omitted.

FIGS. 13(A), (B), and (C) are views that illustrate a radar apparatus 170 of the present embodiment having a configuration in which slot waveguide elements 1301a to 1301c and 1302a to 1302c and slot reflection elements 1303a to 1303c and 1304a to 1304c are further added to the configuration of Embodiment 2. The slot waveguide elements 1301a to 1301c are formed by cutting the conductor layer 704 at a distance L10 on the −X direction side, i.e. the main beam direction side, away from the ends of the diamond-shaped antenna elements comprising the antenna element 701. Likewise, the slot waveguide elements 1302a to 1302c are formed by cutting the conductor layer 704 at a distance L10 on the main beam direction (+x direction) side away from the ends of the diamond-shaped antenna elements comprising the antenna element 702. In this case, for example, the slot waveguide element length is set as 3.2 mm (½ wavelength or less), the slot waveguide element width is set as 0.2 mm, and the distance L10 is set as 1.5 mm.

The slot reflection elements 1303a to 1303c are formed by cutting the conductor layer 704 at a distance L11 on the +X direction side, i.e. side in the opposite direction to the main beam, away from the ends of the diamond-shaped antenna elements comprising the antenna element 701. At this time, the slot reflection elements 1303a and 1303c are disposed in a condition in which they are shifted in the Y direction by the distance L12 so as not to intersect, respectively, with the microstrip lines 710 and 709 that are power feeding lines. Likewise, the slot reflection elements 1304a to 1304c are formed at a distance L11 on the side opposite the main beam direction (−X direction) away from the ends of the diamond-shaped antenna elements comprising the antenna element 702. The slot reflection elements 1304a and 1304c are disposed in a condition in which they are shifted in the Y direction by the distance L12 so as not to intersect, respectively, with the microstrip lines 712 and 711 that are power feeding lines. In this case, for example, the slot reflection element length is set as 3.6 mm (½ wavelength or more), the slot waveguide element width is set as 0.2 mm, and the distances L11 and L12 are set as 1 mm and 3 mm.

In this connection, the slot waveguide elements 1301a to 1301c and 1302a to 1302c correspond to waveguide elements of the present invention, and the slot reflection elements 1303a to 1303c and 1304a to 1304c correspond to reflection elements of the present invention.

By adopting the above configuration, since radio waves that are emitted from the antenna elements 701 and 702 are further directed toward the main beam direction side by the slot waveguide elements 1301a to 1301c and 1302a to 1302c and the slot reflection elements 1303a to 1303c and 1304a to 1304c, the gain and F/B ratio can be improved.

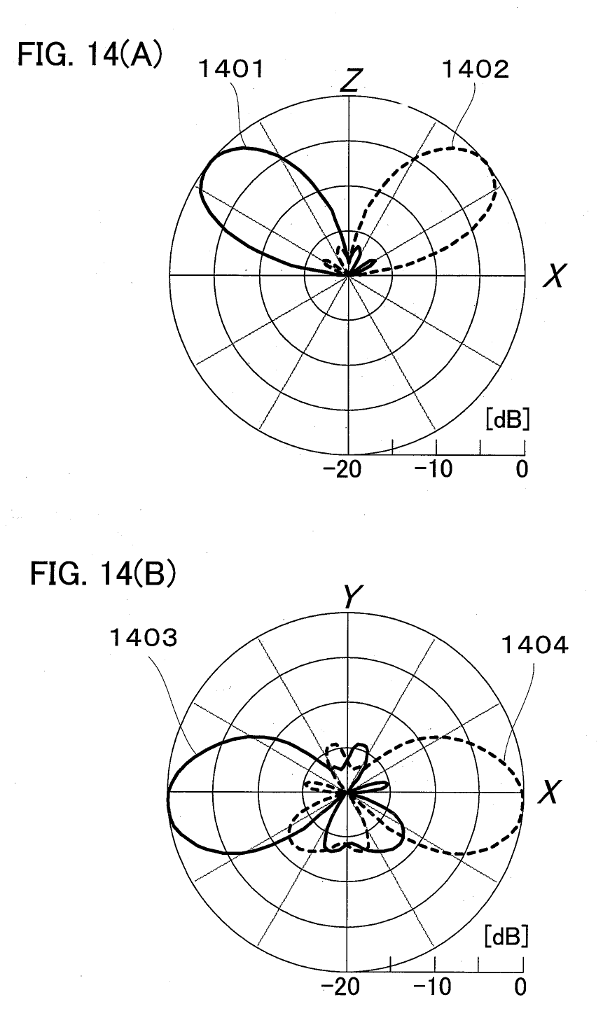

FIG. 14 includes two views illustrating the directivity when the antenna element 701 shown in FIG. 13 is excited from the power feeding point E by the microstrip line 709 and the directivity when the antenna element 702 is excited from the power feeding point G by the microstrip line 711, in which FIG. 14(A) is a view that illustrates the directivity of a vertical (XZ) plane and FIG. 14(B) is a view that illustrates the directivity of a conical plane where an elevation angle θ is 50 degrees.

In FIG. 14, directivities 1401 and 1403 indicate the directivity of a vertically polarized wave Eθ component when the antenna element 701 is excited from the power feeding point E, and it can be confirmed that the main beam is oriented in the −X direction. At this time, the directivity gain of the main beam is 14 dBi.

Further, directivities 1402 and 1404 indicate the directivity of a vertically polarized wave Eθ component when the antenna element 702 is excited from the power feeding point G, and it can be confirmed that the main beam is oriented in the +X direction. Thus, the main beam direction can be switched in two directions by switching excitation for the antenna elements 701 and 702, and the detection range can be switched. Further, comparing the directivity shown in FIG. 14(B) and that in FIG. 8(B), it can be confirmed that the gain and the F/B ratio are improved by loading the slot waveguide elements 1301a to 1301c and 1302a to 1302c and the slot reflection elements 1303a to 1303c and 1304a to 1304c.

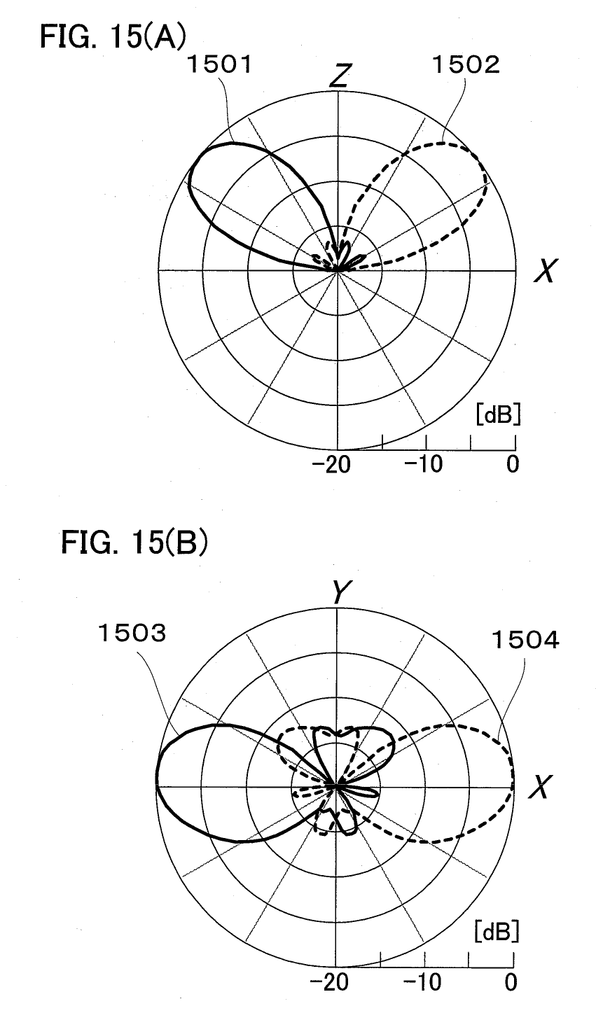

FIG. 15 includes two views illustrating the directivity when the antenna element 701 is excited from the power feeding point F by the microstrip line 710 and the directivity when the antenna element 702 is excited from the power feeding point H by the microstrip line 712, in which FIG. 15(A) is a view that illustrates the directivity of a vertical (XZ) plane, and FIG. 15(B) is a view that illustrates the directivity of a conical plane where an elevation angle θ is 50 degrees.

In FIG. 15, directivities 1501 and 1503 indicate the directivity of a vertically polarized wave Eθ component when the antenna element 701 is excited from the power feeding point F, and directivities 1502 and 1504 indicate the directivity of a vertically polarized wave Eθ component when the antenna element 702 is excited from the power feeding point H, and it can be confirmed that the gain and F/B ratio are enhanced in comparison to the case shown in FIG. 9(B).

As described above, according to the present embodiment, by disposing slot waveguide elements and slot reflection elements on the same surface as the antenna elements at predetermined intervals on the main beam direction side and the side opposite the main beam direction side of the antenna element 701 and 702, a radar apparatus having directivity with a good F/B ratio and a high gain can be realized. It is therefore possible to lengthen the detection distance, decrease the reception level of radio waves that are reflected back from obstacles other than those in the main beam direction, and improve the detection accuracy.

Although a slot element has been described according to the present embodiment, a similar effect can be obtained by using linear waveguide elements and linear reflection elements in the linear conducting element configuration that was described with respect to Embodiment 1.

Further, although a case has been described according to the present embodiment in which a plurality of waveguide elements and a plurality of reflection elements are used, a similar effect can be obtained by using at least one element of either of these elements.

Although in each of the above described embodiments, a description was made with regard to a case in which a single antenna element is configured by linking three diamond-shaped antenna elements or three diamond-shaped slot antenna portions, the number of elements or portions to be linked is not limited as long the number is two or more. Further, as long as the antenna elements can be disposed in a condition in which they have different directivities to each other and comprise a plurality of power feeding points, the antenna elements can be adopted in conformity with the detection range.

Further, although in each of the above described embodiments, a description was made for a configuration comprising two antenna elements, the present invention may be applied as a configuration comprising three or more antenna elements.

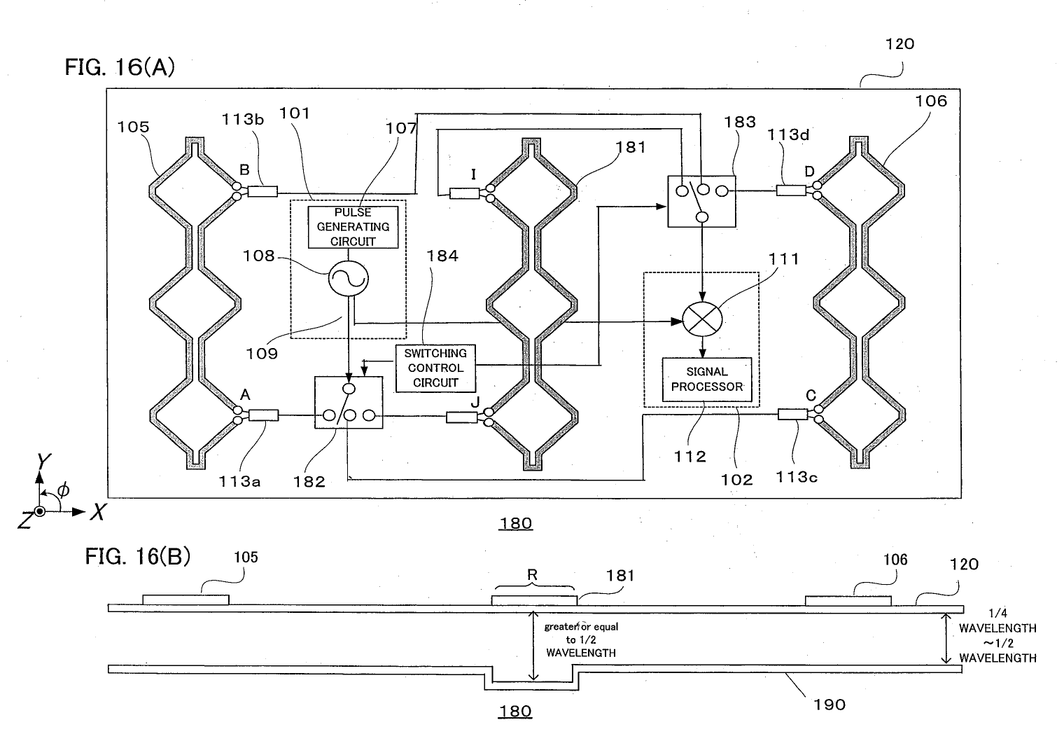

FIGS. 16 (A) and (B) are configuration diagrams of a radar apparatus 180 that comprises a third antenna element 181 between the antenna element 105 and the antenna element 106. However, parts that are the same as or correspond to parts in FIGS. 1 and 2 are assigned the same reference numerals and detailed explanations thereof are omitted.

In the radar apparatus 180, although the antenna element 181 has a configuration in which, similarly to the antenna elements 105 and 106, three diamond-shaped antenna elements are connected in an columnar (end-to-end) condition, the lengths of the linear detour elements respectively provided on the diamond-shaped antenna elements at the two ends of the antenna element 181 are shorter than in the configurations of the antenna elements 105 and 106. Further, as shown in FIG. 16(B), a concave reflector 190 is provided, and a distance to the reflector 190 is set to ½ wavelength or more only with respect to a portion R at which the antenna element 181 is provided. Thus, the phase difference with respect to the left and right sides of the antenna element 181 decreases and the main beam direction can be inclined to a position nearer the +Z direction than the main beam direction of the antenna element 106.

In this connection, in FIG. 16(A), a power feeding point J corresponds to a first power feeding point of the present invention and a power feeding point I corresponds to a second power feeding point of the present invention.

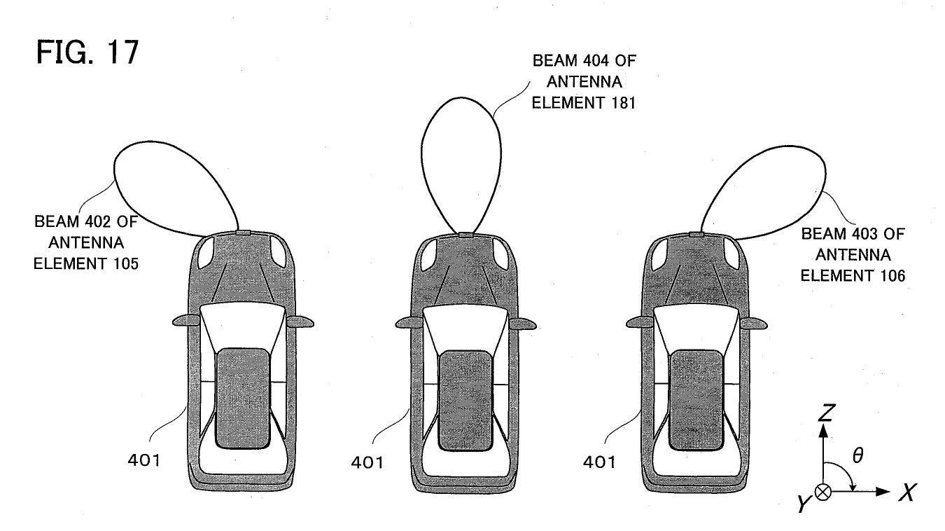

By comprising the antenna element 105 having a main beam direction that is inclined in the −X direction from the +Z direction, the antenna element 106 having a main beam direction that is inclined in the +X direction from the +Z direction, and the antenna element 181 having a main beam direction that is inclined in a direction close to the +Z direction, as shown in FIG. 17, the radar apparatus 180 configured as described above can also cover the detection range in the front direction that is a dead angle for the main beam directions of the antenna elements 105 and 106.

Further, the radar apparatus 180 according to the present embodiment comprises switching elements 182 and 183 instead of the switching elements 103 and 104, and a switching control circuit 184 instead of the switching control circuit 110. The switching element 182 selectively connects the power feeding points A, C, and J of the antenna elements 105, 106, and 181 and the transmitter 101 based on control of the switching control circuit 184. The switching element 183 selectively connects the power feeding points B, D, and I of the antenna elements 105, 106, and 181 and the receiver 102. Further, the switching elements 182 and 183 operate based on the control of the switching control circuit 184.

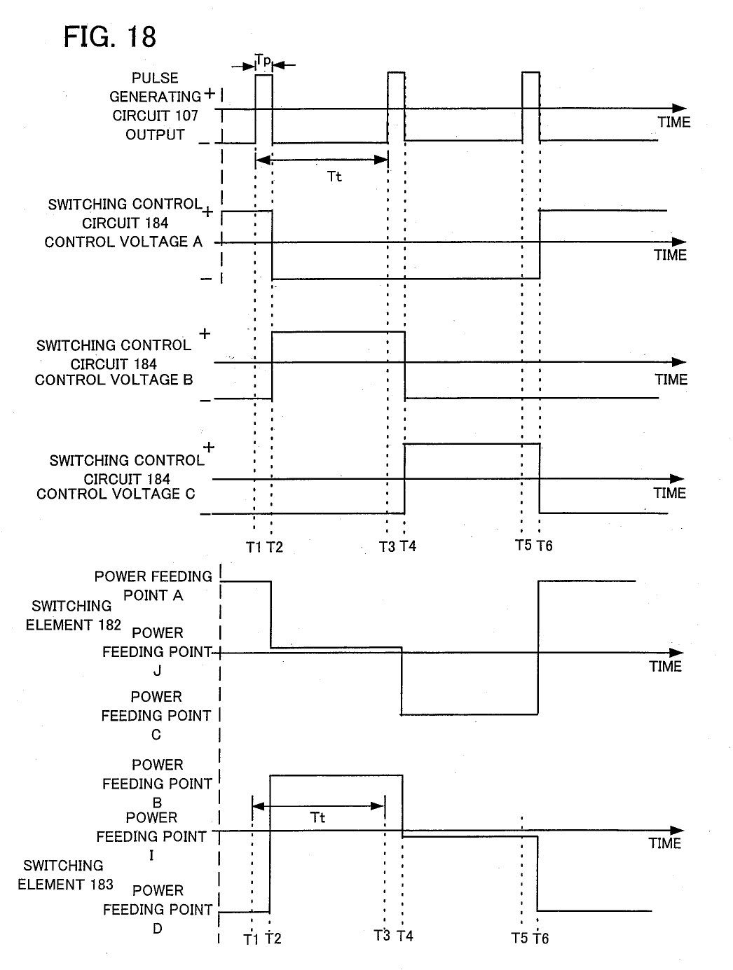

Next, a beam switching operation of the radar apparatus 180 will be described referring to the timing chart shown in FIG. 18.

Similarly to Embodiment 1, the pulse generating circuit 107 of the transmitter 101 generates, for example, a pulse signal for which a pulse width Tp=0.5 ns to 1 ns at intervals of a period Tt=100 ns to 10 μs from a time T1.

At this time, the switching element 182 performs switching operations so that at timings at which the control voltages A, B, and C are respectively switched from positive (+) to negative (−) or from negative (−) to positive (+), the power feeding point A of the antenna element 105, the power feeding point J of the antenna element 181, and the power feeding point C of the antenna element 106 are switched and connected in sequence. At this time, the object to be switched to after the power feeding point C is the power feeding point A, and after that the power feeding point J is switched to.

Immediately after a pulse signal of the pulse width Tp is transmitted from the pulse generating circuit 107, more specifically, at time T2, control is executed to switch the control voltage A of the switching control circuit 184 from positive (+) to negative (−). Simultaneously, control is executed to switch the control voltage B of the switching control circuit 184 from negative (−) to positive (+). At this time, the control voltage C remains in a negative (−) state.

As shown in FIG. 18, by performing the above described control, in the period from the time T1 to T2 in which a pulse signal is generated, since a 26 GHz pulse signal that is output from the transmitter 101 is output to the power feeding point A of the antenna element 105, the antenna element 105 is excited.

Next, immediately after a pulse signal that is generated at time T3 is transmitted, i.e. at time T4, the control voltage B of the switching control circuit 184 is controlled to switch from positive (+) to negative (−), and the control voltage C is controlled to switch from negative (−) to positive (+). At this time, the control voltage A remains in a negative (−) state.

More specifically, in the period from time T3 to T4 in which a second pulse signal is generated, since the 26 GHz pulse signal that is output from the transmitter 101 is output to the power feeding point J of the antenna element 181, the antenna element 181 is excited.

Further, immediately after a pulse signal that is generated at time T5 is transmitted, i.e. at time T6, the control voltage C of the switching control circuit 184 is controlled to switch from positive (+) to negative (−), and the control voltage A is controlled to switch from negative (−) to positive (+). At this time, the control voltage B remains in a negative (−) state.

Accordingly, in the period from time T5 to T6 in which a third pulse signal is generated, since the 26 GHz pulse signal that is output from the transmitter 101 is output to the power feeding point C of the antenna element 106, the antenna element 106 is excited.

The switching element 183 is also controlled by the switching control circuit 184, and performs switching operations so that at timings at which the control voltages A, B, and C are respectively switched from positive (+) to negative (−) or from negative (−) to positive (+), the power feeding point B of the antenna element 105, the power feeding point I of the antenna element 181, and the power feeding point D of the antenna element 106 are switched and connected in sequence. At this time, the object to be switched to after the power feeding point D is the power feeding point B, and after that the power feeding point I is switched to.

In the case illustrated in FIG. 18, in a period from time T1 to T2 in which a pulse signal is generated, the switching element 183 is connected to the power feeding point D of the antenna element 106. More specifically, the antenna element 106 is connected to the receiver 102 and the antenna element 105 is connected to the transmitter 101.

Further, in the period from time T3 to T4 in which a second pulse signal is generated, the switching element 183 is connected to the power feeding point B of the antenna element 105. More specifically, the antenna element 105 is connected to the receiver 102 and the antenna element 181 is connected to the transmitter 101.

Furthermore, in the period from time T5 to T6 in which a third pulse signal is generated, the switching element 183 is connected to the power feeding point I of the antenna element 181. More specifically, the antenna element 181 is connected to the receiver 102 and the antenna element 106 is connected to the transmitter 101.

Thereafter, at timings at which the pulse generating circuit 107 generates a pulse signal, the switching elements 182 and 183 perform a switching operation each time the control voltages A, B, and C of the switching control circuit 184 are switched, and the antenna elements 105, 181, and 106 conduct transmitting and receiving operations on a time-division basis at respective time differences of a period Tt. As shown in FIG. 17, the radar apparatus 180 can repeatedly switch the detection direction in the sequence of beams 402, 404, and 403 and obtain a wide detection range without any blind spots.

In this connection, although the above described configuration is based on the radar apparatus 100 of Embodiment 1, the configuration may also be based on the configuration described in Embodiments 2 to 4.

Further, although in the above description the switching elements 182 and 183 are described as conducting switching such that connections between the respective antenna elements and the transmitter 101 or the receiver 102 are always carried out between adjacent antenna elements, a configuration may also be adopted in which switching is performed between non-adjacent antenna elements, such as switching in the order antenna element 105, antenna element 106, and antenna element 108.

More specifically, as long as switching of each antenna element and the receiver 102 is performed in a manner that follows the switching of each antenna element and the transmitter 101, and switching is performed such that an antenna element is next connected to the receiver immediately after it is connected to the transmitter 101, the present invention is not limited by the order of switching the antenna elements.

Further, although in the above description with respect to the switching elements 182 and 183, the transmission and the reception are performed on the time-division basis for each switching element and the antenna element immediately after connected to the transmitter 101 is connected to the receiver 102, the control of connection may be performed so that all the antenna elements are sequentially connected to the receiver 102 after sequentially connected to the transmitter 101.

Furthermore, although a configuration that uses three antenna elements consisting of the antenna elements 105, 106, and 181 is described above, when increasing the number of antenna elements further, by disposing each antenna element in parallel and changing the length of the linear detour elements and the distance to the reflector, the detection directions of the antenna elements can be dispersed to obtain a wide detection range overall.

Further, although each of the above described embodiments was described as an embodiment in which the main beam directions of the respective antenna elements are all different, a configuration may also be adopted in which at least some of the main beam directions are different and some of them are identical. In this case, even if one antenna element is broken from among a plurality of antenna elements whose main beam directions are identical, the detection direction can be covered by the other antenna elements.

Further, although a description was made according to the above described embodiments in which, as shown by the time charts of FIGS. 3 and 18, a transmitting operation by the transmitter 101 with respect to an antenna element and a receiving operation by the receiver 102 with respect to another antenna element are performed in parallel in the same time period, the configuration may be one in which a transmitting operation and a receiving operation are performed in parallel in some time periods only, to take into account a delay time in a circuit and the like.

Furthermore, although in each of the above described embodiments antenna elements were used as planar antennas that are disposed in the same plane, the present invention may also be realized using an antenna having a three-dimensional shape as long as the antenna is sufficiently small for use in a vehicle. That is, the present invention is not limited by the specific shape or configuration of the antenna elements.

The radar apparatus according to the present invention has an effect whereby it is possible to prevent a deterioration in reception sensitivity while broadening a detection range using a plurality of antenna elements and, for example, is useful as a radar apparatus for a vehicle or the like.

What is claimed is:

1. A radar apparatus, comprising:
a plurality of antenna elements each having a first power feeding point and a second power feeding point;
a transmitter;
a receiver;
first antenna switch which selectively connects the first power feeding point of each of the plurality of antenna elements and the transmitter;
second antenna switch which selectively connects the second power feeding point of each of the plurality of antenna elements and the receiver; and
a control portion which controls a connection of the first antenna switch and the second antenna switch;
wherein, at least one of the plurality of antenna elements has a directivity different than another of the plurality of antenna elements.

2. The radar apparatus according to claim 1, wherein the control portion controls the first antenna switch and the second antenna switch so that when the first power feeding point of either one of the antenna elements is connected to the transmitter, the second power feeding point of either one of the antenna elements is connected to the receiver at the same time.

3. The radar apparatus according to claim 2, wherein the control portion controls the first antenna switch and the second antenna switch such that:
the first power feeding points of the plurality of antenna elements and the transmitter are sequentially connected;
the second power feeding points of the plurality of antenna elements and the receiver are sequentially connected in a manner that follows the sequential connections of the first power feeding points and the transmitter; and
the antenna element for which the second power feeding point and the receiver are connected is the antenna element for which a connection between the first power feeding point and the transmitter is just after finishing.

4. The radar apparatus according to claim 1, wherein the control portion controls the first antenna switch and the second antenna switch so that the second power feeding points of all the antenna element are sequentially connected to the receiver after the first power feeding points of all the antenna elements are sequentially connected to the transmitter.

5. The radar apparatus according to claim 1, wherein each of the antenna elements have the same directivity irrespective of whether the antenna elements are fed with power from the first power feeding point or the second power feeding point.

6. The radar apparatus according to claim 1, wherein the plurality of antenna elements are each planar antennas that are disposed on the same surface, and are provided with a reflector that is disposed at a predetermined distance from and in parallel with the antenna element surface.

7. The radar apparatus according to claim 1, wherein
the transmitter and the receiver transmits and receive pulse signals; and
the control portion controls the first antenna switch or the second antenna switch at a timing of transmitting the pulse signal of the transmitter.

8. The radar apparatus according to claim 1, wherein
the plurality of antenna elements includes a first antenna element and a second antenna element.

9. The radar apparatus according to claim 6, wherein
the antenna elements comprise:
diamond-shaped antenna portions in which a first to a fourth linear conducting element that have a length of from a ¼ wavelength to a ⅜ wavelength of a usable frequency of the transmitter and the receiver are disposed in a diamond shape, and in which the first linear conducting element and the second linear conducting element that are adjacent are connected and the third linear conducting element and the fourth linear conducting element that are adjacent are connected;
linear coupling elements having a predetermined length which, for a pair of the diamond-shaped antenna portions that are facing each other, connect the second linear conducting element of one of the diamond-shaped antenna portions with the first linear conducting element of the other of the diamond-shaped antenna portions and connect the fourth linear conducting element of the one of the diamond-shaped antenna portions with the third linear conducting element of the other of the diamond-shaped antenna portions to thereby link a plurality of the diamond-shaped antenna portions; and
fold shape linear detour elements that have a predetermined length overall that respectively connect the first linear conducting element and the third linear conducting element of the diamond-shaped antenna portion at one end of the plurality of the diamond-shaped antenna portions that are linked, and the second linear conducting element and the fourth linear conducting element of the diamond-shaped antenna portion at another end of the plurality of the diamond-shaped antenna portions that are linked;
wherein the first power feeding point and the second power feeding point are respectively provided in a connection portion between the first linear conducting element and the second linear conducting element of any two diamond-shaped antenna portions of the plurality of diamond-shaped antenna portions.

10. The radar apparatus according to claim 9, wherein the predetermined length of the linear detour element and a predetermined space from the antenna element to the reflector differs for each of a plurality of the antenna elements in accordance with a directivity of the antenna element.

11. The radar apparatus according to claim 6, wherein each antenna element comprises:
a dielectric substrate having a predetermined dielectric constant;
a conductor layer that is formed on the dielectric substrate;
array antenna slots formed on the conductor layer and having:
diamond-shaped antenna slots in which a first to a fourth linear slot having a length of from ¼ wavelength to ⅜ wavelength of a usable frequency of the transmitter and the receiver are disposed in a diamond shape, and in which the first linear slot and the second linear slot that are adjacent are connected and the third linear slot and the fourth linear slot that are adjacent are connected,
linear coupling slots having a predetermined length which, for a pair of the diamond-shaped antenna slots that are facing each other, connect the second linear slot of one of the diamond-shaped antenna slots with the first linear slot of the other of the diamond-shaped antenna slots and connect the fourth linear slot of the one of the diamond-shaped antenna slots with the third linear slot of the other of the diamond-shaped antenna slots to thereby link a plurality of the diamond-shaped antenna slots, and
fold shape linear detour slots that have a predetermined length overall that respectively connect the first linear slot and the third linear slot of the diamond-shaped antenna slot at one end of the plurality of the diamond-shaped antenna slots that are linked, and the second linear slot and the fourth linear slot of the diamond-shaped antenna slot at another end of the plurality of the diamond-shaped antenna slots that are linked; and
connection conductors that are disposed so as to be separated from each of the first to the fourth linear slots of at least one diamond-shaped antenna slot of the array antenna slots;
wherein, the first power feeding point and the second power feeding point are respectively provided in a connection portion of the first linear slot and the second linear slot of any two diamond-shaped antenna slots of the plurality of diamond-shaped antenna slots.

12. The radar apparatus according to claim 11, wherein the predetermined length of the linear detour slot and a predetermined space from the antenna element to the reflector differs for each of a plurality of the antenna elements in accordance with a directivity of the antenna element.

13. The radar apparatus according to claim 12, further comprising microstrip lines that are respectively disposed in the first power feeding point and the second power feeding point provided on a surface on an opposite side to a surface on which the conductor layer of the dielectric substrate is formed.

14. The radar apparatus according to claim 11, further comprising:
a conductor plate that is disposed so as to connect the reflector and the dielectric substrate.

15. The radar apparatus according to claim 11, further comprising at least one waveguide element having a length that is less than or equal to half a wavelength of the usable frequency and which is formed in a condition in which the waveguide elements are separated by a predetermined distance on a same surface of a plurality of the antenna elements.

16. The radar apparatus according to claim 11, further comprising at least one reflection element having a length that is less than or equal to half a wavelength of the usable frequency and which is formed in a condition in which the reflection elements are separated by a predetermined distance on a same surface of a plurality of the antenna elements.
